(19) United States
(12) Patent Application Publication
(10) Pub. No.: US 2025/0343582 A1
(43) Pub. Date: Nov. 6, 2025

(54) CHANNEL STATE INFORMATION CONFIGURATIONS FOR JOINT TRANSMISSIONS FROM MULTIPLE TRANSMISSION-RECEPTION POINTS

(71) Applicant: QUALCOMM Incorporated, San Diego, CA (US)

(72) Inventors: Jing DAI, Beijing (CN); Faris RASSAM, El Cajon, CA (US); Mostafa KHOSHNEVISAN, San Diego, CA (US)

(21) Appl. No.: 18/871,079

(22) PCT Filed: Aug. 5, 2022
(86) PCT No.: PCT/CN2022/110454

§ 371 Date: Dec. 2, 2024

(51) Int. Cl. H04B 7/06; H04B 7/024; H04W 8/22; H04W 76/28

(52) U.S. Cl. CPC H04B 7/0626; H04B 7/024; H04W 8/22; H04W 76/28

(57) ABSTRACT

Methods, systems, and devices for wireless communication are described to support configuring channel measurement resources (CMRs) for channel state information (CSI) reporting for coherent joint transmissions (CJTs) via multiple transmission-reception points (TRPs). A user equipment (UE) may transmit, to a network entity, an indication of a capability of the UE to support a CMR that includes two or more CSI-RS resources for CJT CSI reporting for multiple TRPs. Based on the indicated capability of the UE, the network entity may transmit control signaling indicating a CMR configuration, where the control signaling identifies a set of CSI-RS resources for CJT CSI reporting for the multiple TRPs. Based on the CMR configuration, the UE may transmit, to a network entity a CJT CSI report for the multiple TRPs, where the CJT CSI report may be determined based on the CMR configuration.

### CROSS REFERENCE

The present Application is a 371 national stage filing of International PCT Application No. PCT/CN2022/110454 by DAI et al. entitled “CHANNEL STATE INFORMATION CONFIGURATIONS FOR JOINT TRANSMISSIONS FROM MULTIPLE TRANSMISSION-RECEPTION POINTS,” filed Aug. 5, 2022, which is assigned to the assignee hereof, and which is expressly incorporated by reference in its entirety herein.

### FIELD OF TECHNOLOGY

The following relates to wireless communication, including channel state information (CSI) configurations for joint transmissions from multiple transmission-reception points (TRPs).

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some cases, a UE may communicate with one or more transmission-reception points (TRPs), which may each be a respective example of a network entity, or a portion thereof. In some cases, multiple TRPs may coordinate transmissions to a UE.

### SUMMARY

The described techniques relate to improved methods, systems, devices, and apparatuses that support channel state information (CSI) configurations for joint transmissions from multiple transmission-reception points (TRPs). For example, the described techniques provide for configuring channel measurement resources (CMRs) (e.g., for CSI reporting) for coherent joint transmissions (CJTs) via multiple TRPs. For example, in order to support configuring a CMR for CJT via multiple TRPs (e.g., for CSI reporting for CJT via multiple TRPs), a user equipment (UE) may transmit, to a network entity (e.g., a TRP, another network entity) an indication of a capability of the UE to support a CMR that includes two or more CSI-RS resources for CJT CSI reporting for multiple TRPs.

Based on the indicated capability of the UE, a network entity (e.g., a TRP or other network entity) may determine a CMR configuration for CJTs for the UE. The network entity may transmit, to the UE, control signaling indicating the CMR configuration, where the control signaling identifies a set of CSI-RS resources for CJT CSI reporting for the multiple TRPs. Based on the CMR configuration, the UE may receive one or more CSI-RSs from one or more TRPs, and may measure the resources associated with the one or more CSI-RSs. Based on one or more measurements made by the UE, the UE may transmit, to a network entity (e.g., a TRP, another network entity) a CJT CSI report for multiple TRPs, where the CJT CSI report may be determined based on the CMR configuration. Based on the CSI report from the UE, multiple TRPs may perform CJT to transmit one or more messages to the UE.

A method for wireless communication at a UE is described. The method may include transmitting, to a network entity, an indication of a capability of the UE to support a CMR that includes two or more CSI-RS resources for CJT CSI reporting for multiple TRPs, receiving, from the network entity, control signaling indicating a CMR configuration that identifies a set of CSI-RS resources for CJT CSI reporting for the multiple TRPs, the CMR configuration based on the capability of the UE to support the CMR that includes two or more CSI-RS resources, and transmitting, to the network entity, a CJT channel measurement report determined based on the CMR configuration of the set of CSI-RS resources.

An apparatus for wireless communication is described. The apparatus may include a memory, a transceiver, and at least on processor of a UE, the at least on processor coupled with the memory and the transceiver. The at least one processor configured to cause the apparatus to transmit, to a network entity, an indication of a capability of the UE to support a CMR that includes two or more CSI-RS resources for CJT CSI reporting for multiple TRPs, receive, from the network entity, control signaling indicating a CMR configuration that identifies a set of CSI-RS resources for CJT CSI reporting for the multiple TRPs, the CMR configuration based on the capability of the UE to support the CMR that includes two or more CSI-RS resources, and transmit, to the network entity, a CJT channel measurement report determined based on the CMR configuration of the set of CSI-RS resources.

Another apparatus for wireless communication at a UE is described. The apparatus may include means for transmitting, to a network entity, an indication of a capability of the UE to support a CMR that includes two or more CSI-RS resources for CJT CSI reporting for multiple TRPs, means for receiving, from the network entity, control signaling indicating a CMR configuration that identifies a set of CSI-RS resources for CJT CSI reporting for the multiple TRPs, the CMR configuration based on the capability of the UE to support the CMR that includes two or more CSI-RS resources, and means for transmitting, to the network entity, a CJT channel measurement report determined based on the CMR configuration of the set of CSI-RS resources.

A non-transitory computer-readable medium storing code for wireless communication at a UE is described. The code may include instructions executable by a processor to transmit, to a network entity, an indication of a capability of the UE to support a CMR that includes two or more CSI-RS resources for CJT CSI reporting for multiple TRPs, receive, from the network entity, control signaling indicating a CMR configuration that identifies a set of CSI-RS resources for CJT CSI reporting for the multiple TRPs, the CMR configuration based on the capability of the UE to support the CMR that includes two or more CSI-RS resources, and transmit, to the network entity, a CJT channel measurement report determined based on the CMR configuration of the set of CSI-RS resources.

In some examples of the method, apparatuses, and non-transitory computer-readable medium described herein, receiving the control signaling indicating the CMR configuration may include operations, features, means, or instructions for receiving the control signaling indicating the CMR configuration that identifies the set of CSI-RS resources including two or more CSI-RS resources each associated with a different quantity of ports.

In some examples of the method, apparatuses, and non-transitory computer-readable medium described herein, receiving the control signaling indicating the CMR configuration may include operations, features, means, or instructions for receiving the control signaling indicating the CMR configuration that identifies a respective CSI-RS resource of the set of CSI-RS resources associated with a group of two or more TRPs of the multiple TRPs, the respective CSI-RS resource associated with a set of ports corresponding to the group of two or more TRPs.

In some examples of the method, apparatuses, and non-transitory computer-readable medium described herein, receiving the control signaling indicating the CMR configuration may include operations, features, means, or instructions for receiving the control signaling indicating the CMR configuration that identifies a second respective CSI-RS resource of the set of CSI-RS resources associated with a TRP of the multiple TRPs, the respective CSI-RS resource associated with a second set of ports corresponding to the TRP, where the set of ports may be associated with a first quantity of ports and the second set of ports may be associated with a second quantity of ports differing from the first quantity of ports.

In some examples of the method, apparatuses, and non-transitory computer-readable medium described herein, receiving the control signaling indicating the CMR configuration may include operations, features, means, or instructions for receiving the control signaling indicating the CMR configuration that identifies the set of CSI-RS resources including time resources that include a first time resource, a last time resource, and time resources between the first time resource and the last time resource in one or more consecutive slots, the time resources associated with one communication direction.

In some examples of the method, apparatuses, and non-transitory computer-readable medium described herein, transmitting the CJT channel measurement report may include operations, features, means, or instructions for transmitting, in a discontinuous reception mode, the CJT channel measurement report, where the CTJ channel measurement report is transmitted based on receiving, within a same active time of the discontinuous reception mode, each CSI-RS resource from the set of CSI-RS resources.

In some examples of the method, apparatuses, and non-transitory computer-readable medium described herein, transmitting the CJT channel measurement report may include operations, features, means, or instructions for transmitting, in a discontinuous reception mode, the CJT channel measurement report associated with a hypothesis used for selecting TRPs of the multiple TRPs for CJT, where the CJT channel measurement report for the hypothesis may be transmitted based on receiving, within a same active time of the discontinuous reception mode, each CSI-RS resource that may be associated with the hypothesis from the set of CSI-RS resources.

Some examples of the method, apparatuses, and non-transitory computer-readable medium described herein, may include operations, features, means, or instructions for refraining from transmitting, a second CJT channel measurement report associated with a second hypothesis used for selecting TRPs of the multiple TRPs for CJT based on the UE failing to receive, within the same active time of the discontinuous reception mode, at least one CSI-RS resource that is associated with the second hypothesis from the set of CSI-RS resources.

A method for wireless communication at a network entity is described. The method may include receiving an indication of a capability of a UE to support a CMR that includes two or more CSI-RS resources for CJT CSI reporting for multiple TRPs, transmitting, for the UE, control signaling indicating a CMR configuration that identifies a set of CSI-RS resources for CJT CSI reporting for the multiple TRPs, the CMR configuration based on the capability of the UE to support the CMR that includes two or more CSI-RS resources, and receiving a CJT channel measurement report that is based on the CMR configuration of the set of CSI-RS resources.

An apparatus for wireless communication is described. The apparatus may include a memory and at least one processor of a network entity, the at least one processor coupled with the memory. The at least one processor configured to receive an indication of a capability of a UE to support a CMR that includes two or more CSI-RS resources for CJT CSI reporting for multiple TRPs, transmit, for the UE, control signaling indicating a CMR configuration that identifies a set of CSI-RS resources for CJT CSI reporting for the multiple TRPs, the CMR configuration based on the capability of the UE to support the CMR that includes two or more CSI-RS resources, and receive a CJT channel measurement report that is based on the CMR configuration of the set of CSI-RS resources.

Another apparatus for wireless communication at a network entity is described. The apparatus may include means for receiving an indication of a capability of a UE to support a CMR that includes two or more CSI-RS resources for CJT CSI reporting for multiple TRPs, means for transmitting, for the UE, control signaling indicating a CMR configuration that identifies a set of CSI-RS resources for CJT CSI reporting for the multiple TRPs, the CMR configuration based on the capability of the UE to support the CMR that includes two or more CSI-RS resources, and means for receiving a CJT channel measurement report that is based on the CMR configuration of the set of CSI-RS resources.

A non-transitory computer-readable medium storing code for wireless communication at a network entity is described. The code may include instructions executable by a processor to receive an indication of a capability of a UE to support a CMR that includes two or more CSI-RS resources for CJT CSI reporting for multiple TRPs, transmit, for the UE, control signaling indicating a CMR configuration that identifies a set of CSI-RS resources for CJT CSI reporting for the multiple TRPs, the CMR configuration based on the capability of the UE to support the CMR that includes two or more CSI-RS resources, and receive a CJT channel measurement report that is based on the CMR configuration of the set of CSI-RS resources.

In some examples of the method, apparatuses, and non-transitory computer-readable medium described herein, transmitting the control signaling indicating the CMR configuration may include operations, features, means, or instructions for transmitting the control signaling indicating the CMR configuration that identifies the set of CSI-RS resources including two or more CSI-RS resources each associated with a different quantity of ports.

In some examples of the method, apparatuses, and non-transitory computer-readable medium described herein, transmitting the control signaling indicating the CMR configuration may include operations, features, means, or instructions for transmitting the control signaling indicating the CMR configuration that identifies a respective CSI-RS resource of the set of CSI-RS resources associated with a group of two or more TRPs of the multiple TRPs, the respective CSI-RS resource associated with a set of ports corresponding to the two or more TRPs.

In some examples of the method, apparatuses, and non-transitory computer-readable medium described herein, transmitting the control signaling indicating the CMR configuration may include operations, features, means, or instructions for transmitting the control signaling indicating the CMR configuration that identifies a second respective CSI-RS resource of the set of CSI-RS resources associated with a TRP of the multiple TRPs, the respective CSI-RS resource associated with a second set of ports corresponding to the TRP, where the set of ports may be associated with a first quantity of ports and the second set of ports may be associated with a second quantity of ports differing from the first quantity of ports.

In some examples of the method, apparatuses, and non-transitory computer-readable medium described herein, transmitting the control signaling indicating the CMR configuration may include operations, features, means, or instructions for transmitting the control signaling indicating the CMR configuration that identifies the set of CSI-RS resources including time resources that include a first time resource, a last time resource, and time resources between the first time resource and the last time resource in one or more consecutive slots, the time resources associated with one communication direction.

In some examples of the method, apparatuses, and non-transitory computer-readable medium described herein, receiving, in a discontinuous reception mode, the CJT channel measurement report, wherein the CJT channel measurement report is received based on transmitting, within a same active time of the discontinuous reception mode, each CSI-RS resource from the set of CSI-RS resources.

In some examples of the method, apparatuses, and non-transitory computer-readable medium described herein, receiving the CJT channel measurement report may include operations, features, means, or instructions for receiving the CJT channel measurement report associated with a hypothesis used for selecting TRPs of the multiple TRPs for CJT, where the CJT channel measurement report may be received based on the UE receiving, within a same active time of a discontinuous reception mode of the UE, at least one CSI-RS for each CSI-RS resource that may be associated with the hypothesis from the set of CSI-RS resources.

In some examples of the method, apparatuses, and non-transitory computer-readable medium described herein, the hypothesis may be other than a second hypothesis for which the UE fails to receive, within the same active time of the discontinuous reception mode, at least one CSI-RS resource that may be associated with the second hypothesis from the set of CSI-RS resources.

### BRIEF DESCRIPTION OF THE DRAWINGS

FIG. 1 illustrates an example of a wireless communications system that supports channel state information (CSI) configurations for joint transmissions from multiple transmission-reception points (TRPs) in accordance with one or more aspects of the present disclosure.

FIGS. 2A and 2B illustrate examples of transmission schemes that support CSI configurations for joint transmissions from multiple TRPs in accordance with one or more aspects of the present disclosure.

FIG. 3 illustrates an example of a resource scheme that supports CSI configurations for joint transmissions from multiple TRPs in accordance with one or more aspects of the present disclosure.

FIG. 4 illustrates an example of a wireless communications system that supports CSI configurations for joint transmissions from multiple TRPs in accordance with one or more aspects of the present disclosure.

FIG. 5 illustrates an example of a resource scheme that supports CSI configurations for joint transmissions from multiple TRPs in accordance with one or more aspects of the present disclosure.

FIG. 6 illustrates an example of a process flow that supports CSI configurations for joint transmissions from multiple TRPs in accordance with one or more aspects of the present disclosure.

FIGS. 7 and 8 show block diagrams of devices that support CSI configurations for joint transmissions from multiple TRPs in accordance with one or more aspects of the present disclosure.

FIG. 9 shows a block diagram of a communications manager that supports CSI configurations for joint transmissions from multiple TRPs in accordance with one or more aspects of the present disclosure.

FIG. 10 shows a diagram of a system including a device that supports CSI configurations for joint transmissions from multiple TRPs in accordance with one or more aspects of the present disclosure.

FIGS. 11 and 12 show block diagrams of devices that support CSI configurations for joint transmissions from multiple TRPs in accordance with one or more aspects of the present disclosure.

FIG. 13 shows a block diagram of a communications manager that supports CSI configurations for joint transmissions from multiple TRPs in accordance with one or more aspects of the present disclosure.

FIG. 14 shows a diagram of a system including a device that supports CSI configurations for joint transmissions from multiple TRPs in accordance with one or more aspects of the present disclosure.

FIGS. 15 through 18 show flowcharts illustrating methods that support CSI configurations for joint transmissions from multiple TRPs in accordance with one or more aspects of the present disclosure.

### DETAILED DESCRIPTION

A user equipment (UE) may communicate with one or more transmission-reception points (TRPs) in the uplink, the downlink or both. In some cases, the one or more TRPs may include multiple TRPs that may jointly (e.g., concurrently) communicate with the UE. For example, multiple TRPs may transmit joint downlink information to the UE, such as via a coherent joint transmission (CJT). A CJT from the TRPs may be based on, or associated with, channel state information (CSI) feedback reported by the UE, for example, based on one or more channel measurement resource (CMR) and/or CSI configurations. Based on a CSI and/or CMR configuration, the UE may determine a quantity of computational resources associated with performing CSI measurements and/or reporting (e.g., a quantity of CSI reference signal (CSI-RS) resources or ports for measuring CSI-RS). However, in some cases, CMRs may not be configured for CJTs via multiple TRPs (e.g., may support other transmissions, but may not be configured to support CJTs via multiple TRPs).

The present disclosure provides techniques for configuring CMRs (e.g., for CSI reporting) for CJTs via multiple TRPs. For example, in order to support configuring a CMR for CJT via multiple TRPs (e.g., for CSI reporting for CJT via multiple TRPs), a UE may report a capability to support two or more CSI-RS resources within a CMR (e.g., within a CSI-RS resource set). In some cases, CSI-RS resources associated with different, respective quantities of ports may be configured within a resource set for CJT. For example, two or more TRPs may be included in a resource group (e.g., TRP group) that is associated with one or more respective CSI-RS resources, where the CSI-RS resource(s) are associated a set of ports corresponding to the ports of the TRPs of the group.

A UE may transmit, to a network entity (e.g., a TRP, another network entity) an indication of a capability of the UE to support a CMR that includes two or more CSI-RS resources for CJT CSI reporting for multiple TRPs. Based on the indicated capability of the UE, a network entity (e.g., a TRP or other network entity) may determine a CMR configuration for CJTs for the UE. The network entity may transmit, to the UE, control signaling indicating the CMR configuration, where the control signaling identifies a set of CSI-RS resources for CJT CSI reporting for the multiple TRPs.

Based on the CMR configuration, the UE may receive one or more CSI-RSs from one or more TRPs, and may measure the resources associated with the one or more CSI-RSs. Based on one or more measurements made by the UE, the UE may transmit, to a network entity (e.g., a TRP, another network entity) a CJT CSI report for multiple TRPs, where the CJT CSI report may be determined based on the CMR configuration. Based on the CSI report from the UE, multiple TRPs may perform CJT to transmit one or more messages to the UE.

Aspects of the disclosure are initially described in the context of wireless communications systems. Aspects of the disclosure are further illustrated by and described with reference to a transmission scheme, resource schemes, a process flow, apparatus diagrams, system diagrams, and flowcharts that relate to CSI configurations for joint transmissions from multiple TRPs.

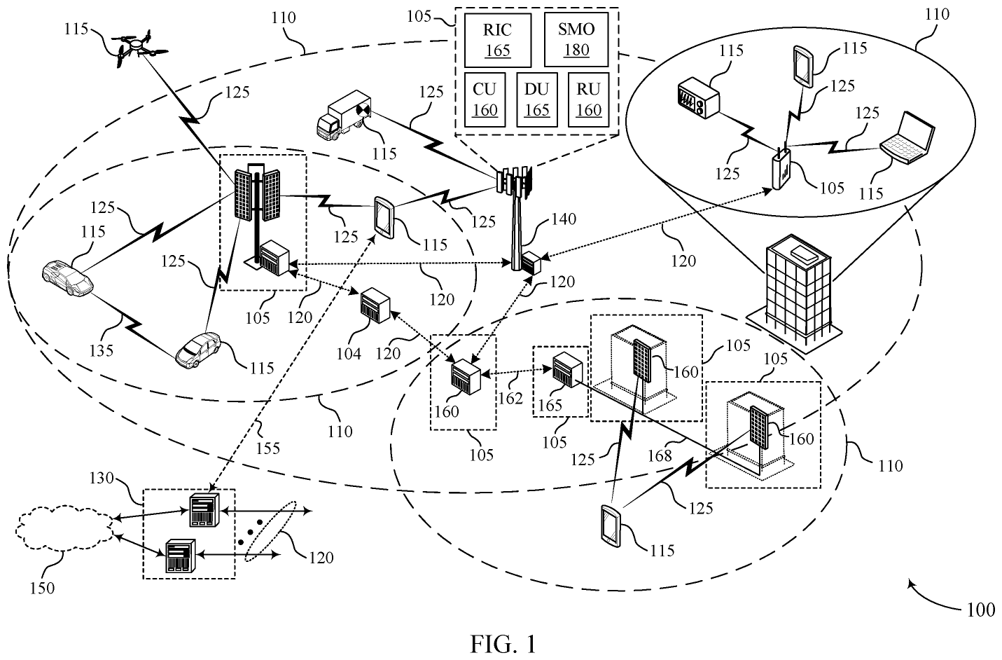

FIG. 1 illustrates an example of a wireless communications system 100 that supports CSI configurations for joint transmissions from multiple TRPs in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support CSI configurations for joint transmissions from multiple TRPs as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1: M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

A UE 115 may transmit, to a network entity (e.g., a TRP, another network entity) an indication of a capability of the UE 115 to support a CMR that includes two or more CSI-RS resources for CJT CSI reporting for multiple TRPs. Based on the indicated capability of the UE 115, a network entity 105 (e.g., a TRP or other network entity 105) may determine a CMR configuration for CJTs for the UE 115. The network entity 105 may transmit, to the UE 115, control signaling indicating the CMR configuration, where the control signaling identifies a set of CSI-RS resources for CJT CSI reporting for the multiple TRPs. Based on the CMR configuration, the UE 115 may receive one or more CSI-RSs from one or more TRPs, and may measure the resources associated with the one or more CSI-RSs. Based on one or more measurements made by the UE 115, the UE 115 may transmit, to a network entity 105 (e.g., a TRP, another network entity 105) a CJT CSI report for multiple TRPs, where the CJT CSI report may be determined based on the CMR configuration. Based on the CSI report from the UE 115, multiple TRPs may perform CJT to transmit one or more messages to the UE 115.

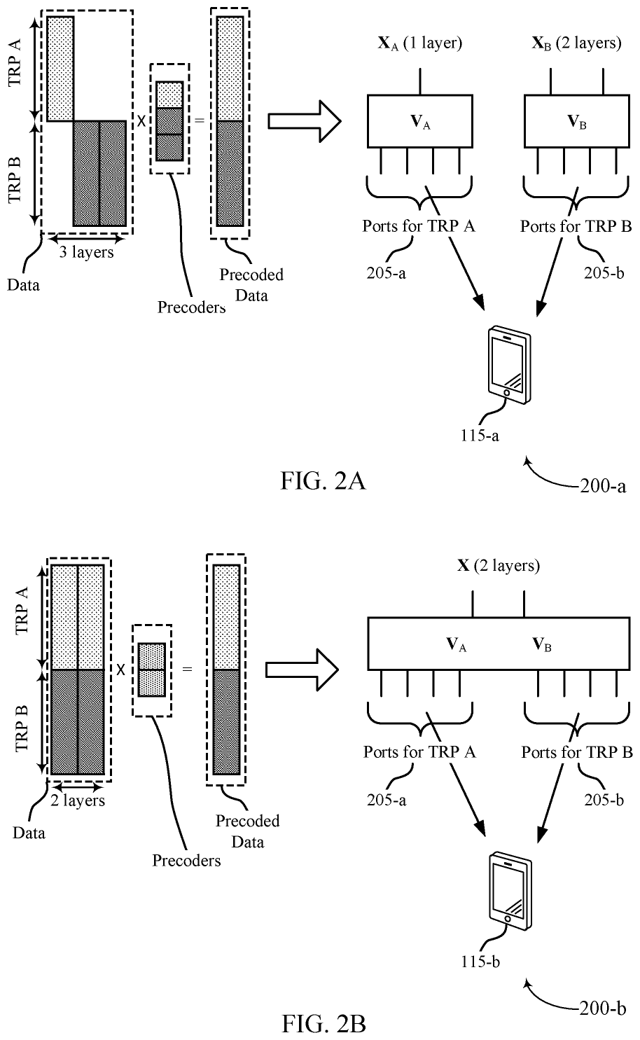

FIGS. 2A and 2B illustrate examples of transmission schemes 200-a and 200-b that support CSI configurations for joint transmissions from multiple TRPs in accordance with one or more aspects of the present disclosure. Transmission schemes 200-a and 200-b may implement or be implemented by one or more aspects of wireless communication system 100. For example, transmission schemes 200-a and 200-b may be implemented by two or more TRPs (e.g., two or more network entities 105, portions thereof), as well as a UE 115-a and a UE 115-b. These devices may be examples of the corresponding devices described with reference to FIG. 1. Transmission schemes 200-a and 200-b may represent schemes for one or more joint transmissions from multiple TRPs to a respective UE 115 (e.g., UE 115-a, UE 115-b). While the examples illustrated by FIGS. 2A and 2B, and described herein, may be associated with two TRPs, the same examples may also be extended to any quantity of multiple TRPs. For example, in some cases, the examples herein may apply to any quantity of multiple TRPs up to four TRPs (e.g., or another quantity of TRPs).

In some cases, as illustrated by FIG. 2A, the TRPs may perform non-coherent joint transmissions to UE 115-a. In such cases, data (e.g., data X) for transmission to UE 115-a may be precoded separately by two or more TRPs, such as a TRP A and a TRP B. Each TRP may be associated with a respective quantity of ports 205 (e.g., four ports 205), and may each use one or more different, respective layers for transmission. For example, a first layer may be used for transmissions from TRP A and two other layers may be used for transmissions from TRP B (e.g., for a total of three layers for transmissions to UE 115-a). Such transmissions may be spatial division multiplexing (SDM) based, for example, based on using different spatial layers for transmissions.

Each TRP may also be associated with a respective precoder for the data transmitted by the TRP. For example, TRP A may use a precoder V_{A} to precode data X_{A}, which data may be associated with one spatial layer. Similarly, TRP B may use a precoder V_{B} to precode data X_{B}, which data may be associated with two spatial layers. The precoders and spatial layers may be configured for a joint transmission from TRPs A and B. After precoding (e.g., separately precoding) the respective data, TRP A and TRP B may transmit (e.g., concurrently transmit) the precoded data to UE 115-a, via the respective ports 205 of the TRPs (e.g., ports 205-a and ports 205-b). Precoding of the data transmitted by TRPs A and B may be represented by an equation such as Equation (1):

$$[ \begin{matrix}{V}_{A} & 0 \\ 0 & {V}_{B}\end{matrix} ] [ \begin{matrix}{X}_{A} \\ {X}_{B}\end{matrix} ] = [ \begin{matrix}{V}_{A} {X}_{A} \\ {V}_{B} {X}_{B}\end{matrix} ] , \qquad ( 1 )$$

where V_{A}X_{A} represents the precoded data transmitted by TRP A, V_{B}X_{B} represents the precoded data transmitted by TRP B, V_{A} represents a precoding matrix (e.g., precoder) used by TRP A, V_{B} represents a precoding matrix (e.g., precoder) used by TRP B, X_{A} represents a data vector including data to be transmitted by TRP A via one layer, and X_{B} represents a data vector including data to be transmitted by TRP B over two layers.

In some cases, as illustrated by FIG. 2B, the TRPs may perform CJT to UE 115-b. In such cases, data (e.g., data X) for transmission to UE 115-b may be precoded jointly by two or more TRPs, such as a TRP A and a TRP B, where the joint precoding may support phase coherence for the joint transmission. Each TRP may be associated with a respective quantity of ports 205 (e.g., four ports 205), and may each use one or more same layers for transmission. For example, two layers may be used for transmissions from TRP A and a same two layers may be used for transmissions from TRP B (e.g., for a total of two layers for transmissions to UE 115-b).

For CJT, each TRP may be associated with a respective precoder for jointly precoding the data transmitted by the TRPs. For example, TRP A may use a precoder V_{A} to precode data X, which data may be associated with the two spatial layers. Similarly, TRP B may use a precoder V_{B} to precode same data X, which data may also be associated with the two spatial layers. The precoders V_{A} and V_{B} may be based on or use a joint codebook (e.g., using a same or similar precoder, such as using a joint spatial dimension, joint frequency dimension, or both), or may be based on or use separate codebooks (e.g., a semi-separate codebook, such as separate in terms of spatial dimension, frequency dimension, or both). The precoders and spatial layers may be configured for a CJT from TRPs A and B. After precoding (e.g., jointly precoding) the data, TRP A and TRP B may transmit (e.g., concurrently transmit, coherently transmit) the precoded data to UE 115-b, via the respective ports 205 of the TRPs. Precoding of the data transmitted by TRPs A and B may be represented by an equation such as Equation (2):

$$[ \begin{matrix}{V}_{A} & 0 \\ 0 & {V}_{B}\end{matrix} ] \cdot X = [ \begin{matrix}{V}_{A} X \\ {V}_{B} X\end{matrix} ] , \qquad ( 2 )$$

where V_{A}X represents the precoded data transmitted by TRP A, V_{B}X represents the precoded data transmitted by TRP B, V_{A} represents a precoding matrix (e.g., precoder) used by TRP A, V_{B} represents a precoding matrix (e.g., precoder) used by TRP B, and X represents a data vector including data to be transmitted by TRP B and TRP A over two layers.

In some cases, CJTs from multiple TRPs may support a larger quantity of ports 205 for CJTs in some frequency bands (e.g., lower frequency bands), where the quantity of ports 205 may be associated with distributed TRPs and/or panels. For example, a single TRP and/or panel with a larger quantity of ports 205 (e.g., 32 ports 205) may have an antenna array size that may be too large for practical deployment. As such, distributed TRPs and/or panels with smaller antenna array sizes may be used, in connection with CJT, to communicate with UEs 115.

In some cases, CJT implementations may be implemented for up to a quantity of TRPs (e.g., four TRPs) within a defined frequency range (e.g., frequency range 1 (FR1)). CJT transmissions may be associated with backhaul connections and synchronization across the multiple TRPs, as well as a same or similar quantity of antenna ports 205 across the multiple TRPs (e.g., for each TRP). In order to perform CJT communications across multiple TRPs, the multiple TRPs may perform one or more CSI reporting techniques with a UE 115 (e.g., UE 115-b). The CSI reporting may be associated with configured CSI-RS resources, which may be associated with a quantity of ports 205 per resources (e.g., 32 ports 205).

A UE 115 may transmit, to a network entity 105 (e.g., a TRP, another network entity 105) an indication of a capability of the UE 115 to support a CMR that includes two or more CSI-RS resources for CJT CSI reporting for multiple TRPs. Based on the indicated capability of the UE 115, a network entity 105 (e.g., a TRP or other network entity 105) may determine a CMR configuration for CJTs for the UE 115. The network entity 105 may transmit, to the UE 115, control signaling indicating the CMR configuration, where the control signaling identifies a set of CSI-RS resources for CJT CSI reporting for the multiple TRPs. Based on the CMR configuration, the UE 115 may receive one or more CSI-RSs from one or more TRPs, and may measure the resources associated with the one or more CSI-RSs. Based on one or more measurements made by the UE 115, the UE 115 may transmit, to a network entity 105 (e.g., a TRP, another network entity 105) a CJT CSI report for multiple TRPs, where the CJT CSI report may be determined based on the CMR configuration. Based on the CSI report from the UE 115, multiple TRPs may perform CJT to transmit one or more messages to the UE 115.

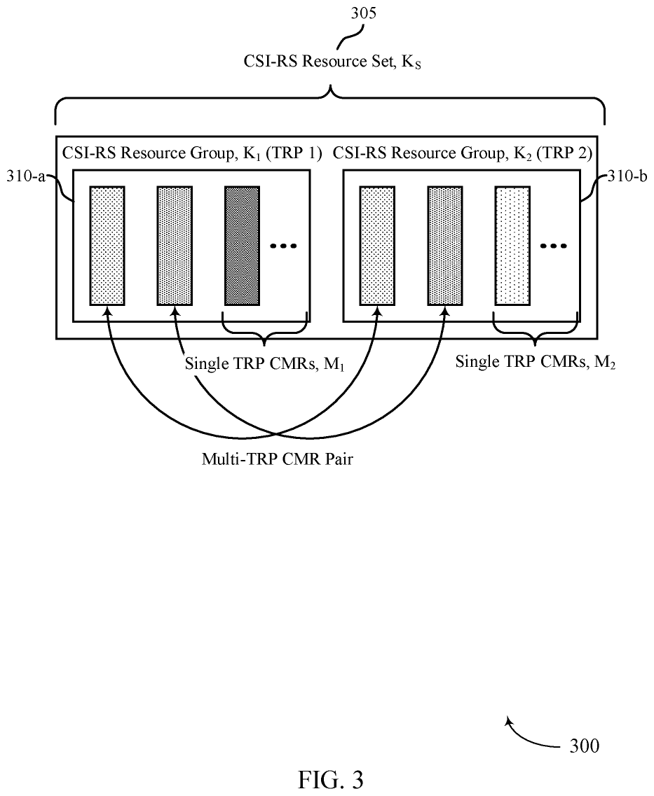

FIG. 3 illustrates an example of a resource scheme 300 that supports CSI configurations for joint transmissions from multiple TRPs in accordance with one or more aspects of the present disclosure. Resource scheme 300 may implement or be implemented by one or more aspects of wireless communication system 100 or transmission schemes 200-a and 200-b. For example, resource scheme 300 may be implemented by two or more TRPs (e.g., two or more network entities 105, portions thereof), as well as a UE 115. These devices may be examples of the corresponding devices described with reference to FIGS. 1-2B. Resource scheme 300 may represent a CSI-RS resource configuration associated with joint transmissions (e.g., CJT) from two or more TRPs to the UE 115 (e.g., UE 115-a, UE 115-b). While the examples illustrated by FIG. 3, and described herein, may be associated with two TRPs, the same examples may also be extended to any quantity of multiple TRPs. For example, in some cases, the examples herein may apply to any quantity of multiple TRPs up to four TRPs (e.g., or another quantity of TRPs).

In some cases, the UE 115, one or more of the TRPs, or both, may construct one or more hypotheses for joint transmissions. For example, each of the one or more hypotheses may be associated with a respective quantity of TRPs used for joint transmissions (e.g., CJT), as well as which TRPs to be used for joint transmissions. CSI reporting (e.g., a CSI and/or CMR configuration) may be configured with one or more single TRP hypotheses, one or more multi-TRP hypotheses, or both. For multi-TRP hypotheses, the UE 115 may report two precoding matrix indicators (PMIs), two rank indicators (RIs), and one channel quality indicator (CQI). In some cases, the one or more hypotheses may be applicable to Type I codebooks (e.g., single panel codebooks).

The resource scheme 300 may illustrate a CSI-RS resource set 305 (e.g., of Kₛ resources), which may include a first CSI-RS resource group 310-a (e.g., of K₁ resources) configured for a TRP 1 and a second CSI-RS resource group 310-b (e.g., of K₂ resources) configured for a TRP 2. Each resource of a CSI-RS resource group 310 may be referred to as a channel measurement resource (CMR), and may be associated with a hypothesis for a single TRP or a multi-TRP transmission scenario, or both.

Within one CSI-RS resource set 305 configured with single TRP and multi-TRP hypotheses, two CSI-RS resource groups 310 (e.g., CMR groups) may be configured and may correspond to two TRPs (e.g., TRP 1 and TRP 2). Up to N pairs (e.g., N equal to 1 or 2) of CMRs may be configured for multi-TRP hypotheses. In the example illustrated by FIG. 3, two pairs (e.g., N=2) of CMRs may be configured. A total of M single TRP hypotheses (e.g., CMRs) may also be configured for the TRPs (e.g., for the two TRPs), where M may be equal to a total of M₁ hypotheses (e.g., M₁ CMRs) associated with TRP 1 and M₂ hypotheses (e.g., M₂ CMRs) associated with TRP 2. Based on how the resources are configured, the M hypotheses may or may not include the 2N paired CMRs.

The UE 115 may report for the single TRP and multi-TRP hypotheses using a CSI-RS resource indicator (CRI). In a first mode (e.g., mode 1), the UE 115 may report one multi-TRP CSI hypothesis (e.g., a determined best hypothesis) and a quantity (e.g., X) of single TRP hypotheses (e.g., determined best hypotheses). The quantity of single TRP hypotheses (e.g., X) may be configurable via RRC (e.g., to a value of 0, 1, 2). If the quantity of single TRP hypotheses is equal to 2 (e.g., X=2), a first reported single TRP hypothesis may be associated with a first CMR group (e.g., CSI-RS resource group 310-a) and a second reported single TRP hypothesis may be associated with a second CMR group (e.g., CSI-RS resource group 310-b). In a second mode (e.g., mode 2), the UE 115 may report one CSI out of all the configured CSI hypotheses (e.g., out of all M+N hypotheses).

A quantity of bits used for CRI reporting (e.g., reported in CSI part 1) in mode 1 may be based on the quantity of single TRP hypotheses (e.g., X). For example, if X=0, one CRI may be used for reporting, where the CRI may include [log ₂ N] bits. If X=1, two CRIs may be used for reporting, where a first CRI may include [log ₂ N] bits and a second CRI may include [log ₂ (M₁+M₂)] bits. If X=2, three CRIs may be used for reporting, where a first CRI may include [log ₂ N] bits, a second CRI may include [log ₂ M₁] bits, and third CRI may include [log ₂ M₂] bits. In mode 2, a quantity of bits used for CRI reporting (e.g., reported in CSI part 1) may include [log ₂ (N+M₁+M₂)] in one CRI.

One or more of the examples of hypotheses described herein may apply to non-coherent joint transmissions, which may be associated with a Type I codebook. One or more other examples of hypotheses may also be configured for, or apply to, CJTs, which may be associated with a Type II codebook. In some cases, for CJT CMR configurations, one CSI-RS resource may be configured per CMR, where the CMR may be associated with a maximum quantity of ports (e.g., 32 ports). In some other cases, for CJT CMR configurations, more than one CSI-RS resource (e.g., K resources) may be configured per CMR, where each CMR may be associated with a same quantity of ports (e.g., representing K TRPs).

In CJT CMR configurations, a quantity of multiple TRPs (e.g., N TRPs) may cooperate for PMI reporting, where a subset of the N TRPs may be selected or determined for CJT. In some cases, the quantity of N TRPs may be configured (e.g., by a network entity 105) via higher layer signaling (e.g., RRC signaling), and one or more parameters associated with the N TRPs may be configured (e.g., by a network entity 105) via higher layer signaling (e.g., RRC signaling). In some such cases, one transmission hypothesis may be supported for CJT (e.g., and more than one hypothesis may not be supported).

In some cases, the quantity of N TRPs (e.g., a quantity of cooperating TRPs) may be selected by the UE 115 and may be reported as part of a CSI report, where N may be greater than or equal to 1 and less than or equal to a total quantity (e.g., maximum quantity) of available (e.g., configured) TRPs (e.g., less than or equal to N_{TRP}, a maximum quantity of TRPs configured by a network entity 105). The UE 115 may also report which TRPs are selected in the N TRPs. In some such cases, one transmission hypotheses or multiple transmission hypotheses (e.g., with a same N value or different N values) may be supported. If the quantity of N TRPs is configured for the UE 115 or selected by the UE 115, the UE 115 may measure CSI according to 2^{N}^{_{TRP}}−1 hypotheses (e.g., 15 hypotheses for N_{TRP}=4). An example of such hypotheses may be shown in Table 1, which may represent different TRP transmission combinations for four TRPs: TRP A, TRP B, TRP C, and TRP D.

TABLE 1

| Total Quantity of TRPs (N_{TRP}) | Hypotheses |
|---|---|
| 1 | {A} |
| | {B} |
| | {C} |
| | {D} |
| 2 | {A, B} |
| | {A, C} |
| | {A, D} |
| | {B, C} |
| | {B, D} |
| | {C, D} |
| 3 | {A, B, C} |
| | {A, B, D} |
| | {A, C, D} |
| | {B, C, D} |
| 4 | {A, B, C, D} |

In some cases, the UE 115 may report CSI corresponding to a quantity of transmission hypotheses (e.g., K hypotheses). In some such cases, a quantity of N TRPs may be configured (e.g., by a network entity 105) via higher layer signaling (e.g., RRC signaling), as well as one or more parameters of the N TRPs. The K transmission hypotheses may be configured (e.g., by a network entity 105) or may be reported by the UE 115. If the UE 115 reports for K transmission hypotheses, the UE 115 may measure CSI according to a configured subset (e.g., configured by a network entity 105) of a set of 2^{N}^{_{TRP}}-1 hypotheses.

Based on a CSI and/or CMR configuration, the UE 115 may determine a quantity of computational resources (e.g., a quantity of active CSI-RS resources or ports, a quantity of occupied computational resources such as O_{CPU}) associated with performing CSI measurements and/or reporting. However, in some cases, CMRs may not be configured for CJTs via multiple TRPs (e.g., may support other transmissions, but may not be configured to support CJTs via multiple TRPs).

The present disclosure provides techniques for configuring CMRs (e.g., for CSI reporting) for CJTs via multiple TRPs. For example, in order to support configuring a CMR for CJT via multiple TRPs (e.g., for CSI reporting for CJT via multiple TRPs), the UE 115 may report a capability to support two or more CSI-RS resources within a CSI-RS resource set 305. In some cases, CSI-RS resources associated with different, respective quantities of ports may be configured within a CSI-RS resource set 305 for CJT. For example, two or more TRPs may be included in a CSI-RS resource group 310 (e.g., TRP group) that is associated with one or more respective CSI-RS resources, where the CSI-RS resource(s) are associated a set of ports corresponding to the ports of the TRPs of the CSI-RS resource group 310.

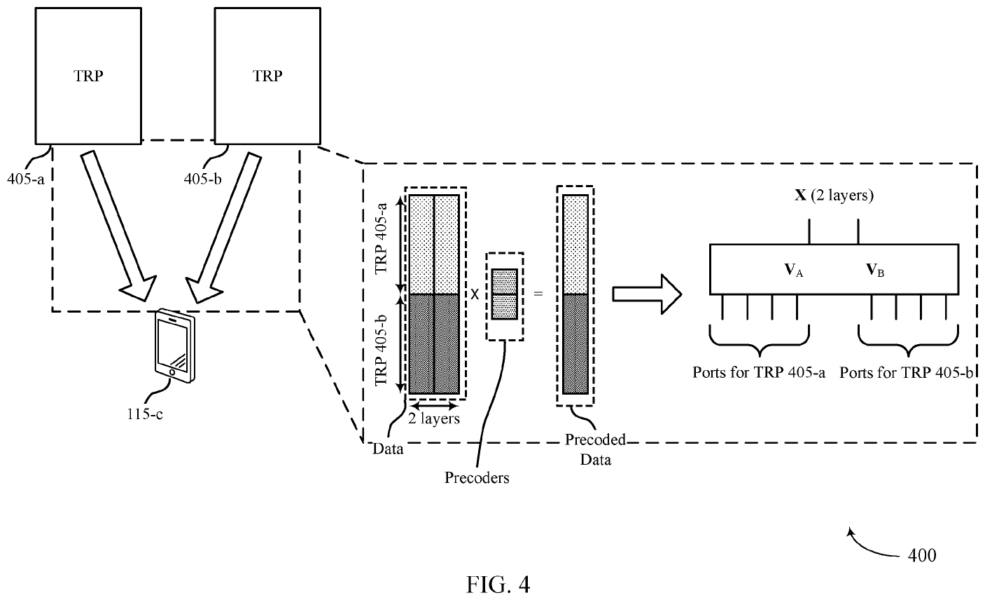

FIG. 4 illustrates an example of a wireless communications system 400 that supports CSI configurations for joint transmissions from multiple TRPs in accordance with one or more aspects of the present disclosure. Wireless communications system 400 may implement or be implemented by one or more aspects of wireless communication system 100, transmission schemes 200-a and 200-b, or resource scheme 300. For example, wireless communications system 400 may include a TRP 405-a, a TRP 405-b, and a UE 115-c, which may be examples of the corresponding devices described with reference to FIGS. 1-3. While the examples illustrated by FIG. 4, and described herein, may be associated with two TRPs, the same examples may also be extended to any quantity of multiple TRPs. For example, in some cases, the examples herein may apply to any quantity of multiple TRPs up to four TRPs (e.g., or another quantity of TRPs).

As described with reference to FIG. 2B, TRPs 405-a and 405-b may communicate with UE 115-c using CJT. For example, data (e.g., data X) for transmission to UE 115-c may be precoded jointly by TRPs 405-a and 405-b, where the joint precoding may support phase coherence for the joint transmission. Each TRP 405 may be associated with a respective quantity of ports (e.g., four ports), and may each use one or more same layers for transmission. For example, two layers may be used for transmissions from TRP 405-a and a same two layers may be used for transmissions from TRP 405-b (e.g., for a total of two layers for transmissions to UE 115-c).

Each TRP 405 may be associated with a respective precoder for jointly precoding the data transmitted by the TRPs 405-a and 405-b. For example, TRP 405-a may use a precoder V_{A} to precode data X, which data may be associated with the two spatial layers. Similarly, TRP 405-b may use a precoder V_{B} to precode the same data X, which data may also be associated with the two spatial layers. The precoders and spatial layers may be configured for a CJT from TRPs 405-a and 405-b. After precoding (e.g., jointly precoding) the data, TRPs 405-a and 405-b may transmit (e.g., concurrently transmit, coherently transmit) the precoded data to UE 115-c, via the respective ports of the TRPs 405.

The CJTs from TRPs 405-a and 405-b may be based on, or associated with, CSI feedback reported by UE 115-c, for example, based on one or more CMR and/or CSI configurations, and associated hypotheses, as described with reference to FIG. 3. Based on the one or more CMR and/or CSI configurations, UE 115-c may determine a quantity of computational resources (e.g., O_{CPU}) associated with performing CSI measurements and/or reporting. However, as described with reference to FIG. 3, some CMR and/or CSI configurations may not support CJTs via multiple TRPs 405.

Accordingly, UE 115-c may support configuring a CMR for CJT via multiple TRPs 405 (e.g., for CSI reporting for CJT via multiple TRPs 405) by reporting a capability to support two or more CSI-RS resources within a CSI-RS resource set. For example, UE 115-c may transmit, to a network entity (e.g., TRP 405-a, TRP 405-b, another TRP 405, another network entity 105), an indication of a capability of UE 115-c to support a CMR that includes two or more CSI-RS resources for CJT CSI reporting for multiple TRPs 405. Based on the indication of the capability of UE 115-c, the network (e.g., TRP 405-a, TRP 405-b, another TRP 405, another network entity 105) may determine a CMR configuration for CJTs to UE 115-c. The network (e.g., TRP 405-a, TRP 405-b, another TRP 405, another network entity 105) may transmit, to UE 115-c control signaling indicating the CMR configuration, where the control signaling identifies a set of CSI-RS resources for CJT CSI reporting for the multiple TRPs 405.

In some cases, CSI-RS resources indicated by the CMR configuration may be associated with different, respective quantities of ports for CJT. For example, two or more TRPs 405 may be included in a resource group (e.g., TRP group) that is associated with one or more respective CSI-RS resources, where the CSI-RS resource(s) are associated a set of ports corresponding to the ports of the TRPs of the group.

Based on the indicated CMR configuration, UE 115-c may receive one or more CSI-RSs from TRP 405-a, TRP 405-b, or both, and may measure the resources associated with the one or more CSI-RSs. Based on one or more measurements made by UE 115-c, UE 115-c may transmit, to a network entity (e.g., TRP 405-a, TRP 405-b, another TRP 405, another network entity 105) a CJT CSI report for multiple TRPs, where the CJT CSI report may be determined based on the CMR configuration. Based on the CSI report from UE 115-c, TRP 405-a, TRP 405-b, one or more other TRPs 405, or any combination thereof may perform CJT to transmit one or more messages to UE 115-c as described herein. For example, based on the CSI report, TRP 405-a, TRP 405-b, one or more other TRPs 405, may determine, select, or configure a respective precoder for precoding and transmitting data to UE 115-c (e.g., via a CJT).

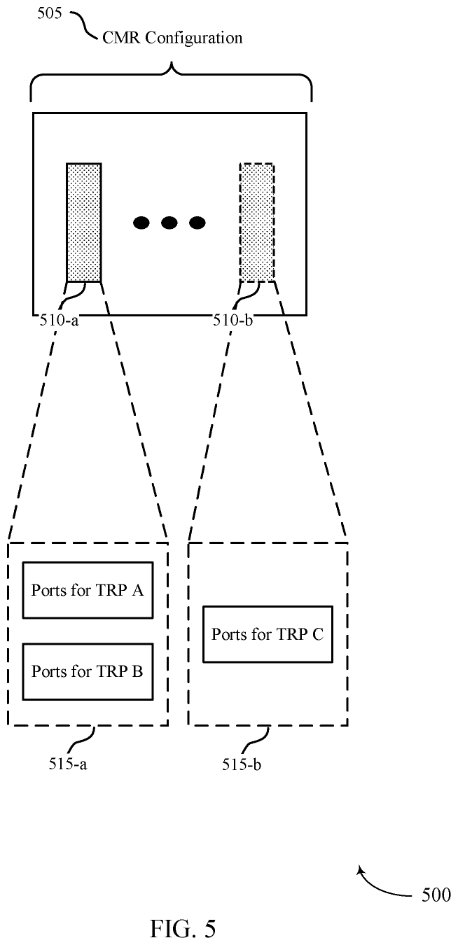

FIG. 5 illustrates an example of a resource scheme 500 that supports CSI configurations for joint transmissions from multiple TRPs in accordance with one or more aspects of the present disclosure. Resource scheme 500 may implement or be implemented by one or more aspects of wireless communications systems 100 or 400, as well as one or more aspects of transmission schemes 200-a and 200-b, or resource scheme 300. For example, resource scheme 500 may be implemented by two or more TRPs and a UE 115, which may be examples of the corresponding devices described with reference to FIGS. 1-4. As described with reference to FIGS. 2B-4, the two or more TRPs may communicate with the UE 115 using CJT.

As described with reference to FIGS. 3 and 4, CJTs from the two or more TRPs may be based on, or associated with, CSI feedback reported by the UE 115. For example, the CJTs may be based on CSI feedback associated one or more CMR and/or CSI configurations, and associated hypotheses, as described with reference to FIGS. 3 and 4. Based on the one or more CMR and/or CSI configurations, the UE 115 may determine a quantity of active resources (e.g., or ports), a quantity of computational resources (e.g., O_{CPU}), or both, associated with performing CSI measurements and/or reporting.

In a first example, a set of CSI-RS resources of a CMR configuration 505 may include one CSI-RS resource 510 (e.g., non-zero power (NZP) CSI-RS resource 510) for all the TRPs configured for the UE 115 (e.g., for the two or more TRPs). In a second example, the set of CSI-RS resources of the CMR configuration 505 may include one respective CSI-RS resource 510 (e.g., NZP CSI-RS resource 510) for each TRP configured for the UE 115 (e.g., may include N_{TRP} resources for all of the N_{TRP} TRPs). In a third example, the set of CSI-RS resources of the CMR configuration 505 may include more than one CSI-RS resource 510 (e.g., NZP CSI-RS resource 510) but less than one respective CSI-RS resource 510 for each TRP configured for the UE 115 (e.g., may include K resources for all of the N_{TRP} TRPs, where 1<K<N_{TRP}).

As described with reference to FIG. 4, for CJT CSI reporting for multiple TRPs, the UE 115 may report whether the UE 115 supports one CSI-RS resource 510 (e.g., NZP CSI-RS resource 510), or more than one CSI-RS resource 510 for a CMR. In some cases, support of at least one CSI-RS resource 510 (e.g., NZP CSI-RS resource 510) may be a mandatory or required UE feature and/or capability (e.g., as mandatory or required by a wireless communications standard). The CMR configuration 505 may be determined by the network (e.g., a network entity 105, a TRP) and indicated to the UE 115 based on the indicated support of one or more CSI-RS resources 510.

In some cases (e.g., in the example of the CMR configuration 505 indicating K CSI-RS resources 510, where 1<K<N_{TRP}), two or more CSI-RS resources 510 each associated with a different quantity of ports may be configured within a CSI-RS resource set used for CJT CSI for multiple TRPs. For example, the CMR configuration 505 may include or indicate a first TRP group 515-a (e.g., a group of TRPs sharing a same spatial domain and/or frequency domain basis selection reported in CSI), which may include TRPs A and B, and which TRP group 515-a may be associated with a CSI-RS resource 510-a. Similarly, the CMR configuration 505 may include or indicate a first TRP group 515-b, which may include a TRP C, and which TRP group 515-b may be associated with a CSI-RS resource 510-b. The CSI-RS resource 510-a may be associated with a set of ports (e.g., 8 ports) corresponding to TRP A and a set of ports (e.g., 8 ports) corresponding to TRP B. Similarly, the CSI-RS resource 510-b may be associated with a set of ports (e.g., 8 ports) corresponding to TRP C. Thus, if each TRP were associated with a same quantity of ports (e.g., 8 ports), CSI-RS resource 510-a may be associated with a different quantity of ports (e.g., 16 ports) than CSI-RS resource 510-b.

In another example, with a TRP A, TRP B, TRP C, and TRP D, each TRP may be associated with a same quantity of ports (e.g., 8 ports) and TRPs B and C may be defined as a TRP group 515 (e.g., a group of TRPs sharing a same spatial domain and/or frequency domain basis selection reported in CSI). A CMR configuration 505 may indicate or include respective CSI-RS resources 510 that may be configured for TRP A and TRP D, and another CSI-RS resource 510 that may be configured for the TRP group 515 that includes TRPs B and C. Thus, a CSI-RS resource set configured by the CMR configuration 505 may include three CSI-RS resources 510, where the respective CSI-RS resources 510 for TRP A and TRP D correspond to the quantity of ports associated with each TRP (e.g., 8 ports) and the CSI-RS resource 510 for TRPs B and C may correspond to twice the quantity of ports associated with each TRP (e.g., 16 ports).

In some cases, the CMR configuration 505 may indicate (e.g., or a wireless communications standard may indicate) that CSI-RS resources 510 (e.g., NZP CSI-RS resources 510) are located in a same slot, or in consecutive slots (e.g., within two slots consecutive in time). The CMR configuration 505 (e.g., or the standard) may additionally indicate that there is no uplink or downlink switching between any of the configured CSI-RS resources (e.g., which may maintain or support phase continuity). For example, there may be no uplink or downlink switching (e.g., a communication direction may be maintained) between a first CSI-RS resource 510 of the CMR configuration 505 and a last CSI-RS resource 510 of the CMR configuration 505.

In some cases, the UE 115 may report a CJT CSI report for multiple TRPs while operating in a discontinuous reception (DRX) mode. For example, the UE 115 may report CSI for a hypothesis of one or more selected TRPs for CJT. In a first example, the UE 115 may not receive any CSI-RS occasions (e.g., CSI-RSs) for any CSI-RS resource associated with a respective hypothesis (e.g., for CJT for multiple TRPs) within a same DRX active time (e.g., no later than a CSI reference resource time, a cutoff time). In such cases, the UE 115 may drop the report associated with the respective hypothesis (e.g., based on failing to receive the CSI-RS occasions). In a second example, the UE 115 may receive at least one set of CSI-RS occasions (e.g., at least one CSI-RS) for each resource associated with a respective hypothesis (e.g., a hypothesis associated with TRPs A, C, and D) within a same DRX active time (e.g., no later than a CSI reference resource time, a cutoff time). That is, related CSI-RSs, such as CSI-RSs associated with the respective hypothesis (e.g., TRPs A, C, and D) may be received at the same DRX active time (e.g., to maintain or support phase continuity). In such cases, the UE 115 may perform the CSI reporting for the respective hypothesis (e.g., may transmit a CJT CSI report associated with the hypothesis).

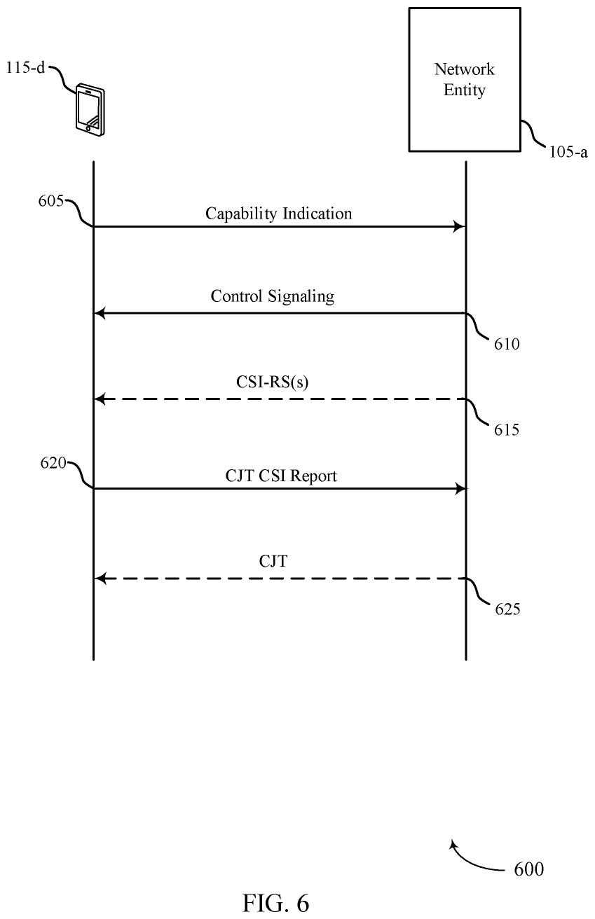

FIG. 6 illustrates an example of a process flow 600 that supports CSI configurations for joint transmissions from multiple TRPs in accordance with one or more aspects of the present disclosure. In some examples, process flow 600 may implement or be implemented by one or more aspects of wireless communications systems 100 or 400, as well as one or more aspects of transmission schemes 200-a and 200-b, resource scheme 300, or resource scheme 500. For example, process flow 600 may be implemented by a UE 115-d and a network entity 105-a (e.g., a TRP or other network entity), which may be examples of a UE 115 and a network entity 105 (e.g., TRP) described with reference to FIGS. 1-5.

In the following description of process flow 600, the operations may be performed in a different order than the order shown, or the operations performed by UE 115-d and network entity 105-a may be performed in different orders or at different times. For example, some operations may also be left out of process flow 600, or other operations may be added to process flow 600. Although UE 115-d and network entity 105-a are shown performing the operations of process flow 600, some aspects of some operations may also be performed by one or more other wireless devices. For example, some actions shown as being performed by network entity 105-a may be performed by another network entity 105, a TRP, or multiple TRPs.

At 605, UE 115-d may transmit, to network entity 105-a, an indication of a capability of the UE to support a CMR that includes two or more CSI-RS resources for CJT CSI reporting for multiple TRPs (e.g., as described with reference to FIGS. 3-5). For example, UE 115-d may, transmit the indication of the capability to support the CMR that includes two or more CSI-RS resources in order to support CSI for CJTs from multiple TRPs.

At 610, network entity 105-a may transmit, to UE 115-d, control signaling indicating a CMR configuration (e.g., as described with reference to FIGS. 3-5) that identifies a set of CSI-RS resources for CJT CSI reporting for the multiple TRPs. The CMR configuration may, for example, be based on the capability of UE 115-d to support the CMR that includes two or more CSI-RS resources (e.g., a CMR configured as described with reference to one or more of FIGS. 3-5). The configuration may indicate one or more time resources, or groupings or ports, associated with the set of CSI-RS resources as described with reference to FIG. 5.

At 615, in some cases, network entity 105-a (e.g., a TRP) or another device (e.g., another network entity 105, another TRP, multiple TRPs) may transmit, to UE 115-d, one or more CSI-RSs via the set of CSI-RS resources. The one or more CSI-RSs may be based on the CMR configuration, or one or more parameters associated therewith. Based on the transmission of the one or more CSI-RSs, UE 115-d may measure the set of CSI-RS resources (e.g., measure the CSI-RS(s)) for performing CSI reporting (e.g., for CJT CSI reporting for multiple TRPs).

At 620, UE 115-d may transmit, to network entity 105-a, a CJT CSI report for the multiple TRPs determined based on the received CSI-RS(s) (e.g., based on the measurements performed by UE 115-d). The CJT CSI report may be associated with one or more hypotheses for selecting TRPs of the multiple TRPs for CJT. For example, as described with reference to FIG. 5, UE 115-d may transmit the CJT CSI report if at least one CSI-RS is received for each resource associated with a respective hypothesis, and may refrain from transmitting the CJT CSI report if CSI-RSs are not received for each resource associated with the respective hypothesis.

At 625, in some cases, network entity 105-a (e.g., a TRP) or another device (e.g., another network entity 105, another TRP, multiple TRPs) may transmit, to UE 115-d, a CJT (e.g., from multiple TRPs). The CJT may be based on the CJT CSI report transmitted by UE 115-d (e.g., one or more parameters for CJT, or one or more TRPs for CJT, among other examples, may be based on the CSI report).

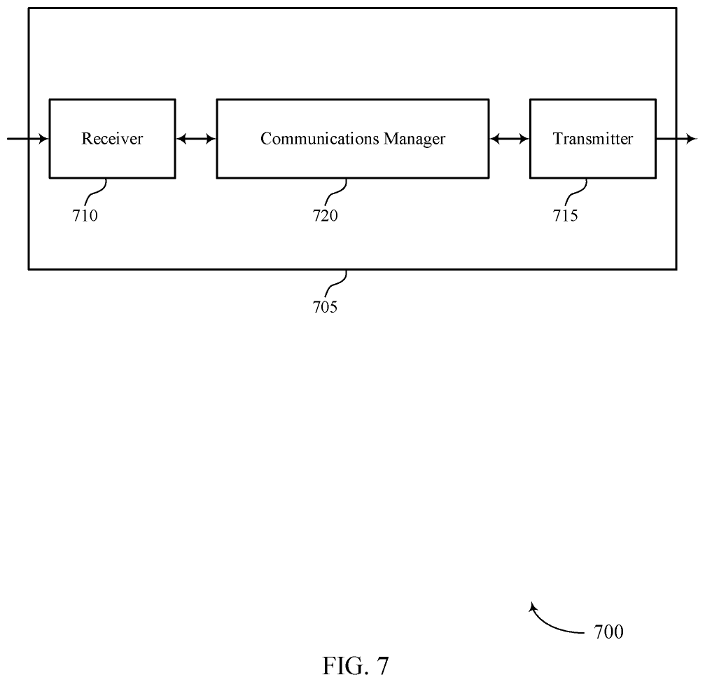

FIG. 7 shows a block diagram 700 of a device 705 that supports CSI configurations for joint transmissions from multiple TRPs in accordance with one or more aspects of the present disclosure. The device 705 may be an example of aspects of a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to CSI configurations for joint transmissions from multiple TRPs). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to CSI configurations for joint transmissions from multiple TRPs). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations thereof or various components thereof may be examples of means for performing various aspects of CSI configurations for joint transmissions from multiple TRPs as described herein. For example, the communications manager 720, the receiver 710, the transmitter 715, or various combinations or components thereof may support a method for performing one or more of the functions described herein.

In some examples, the communications manager 720, the receiver 710, the transmitter 715, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 720, the receiver 710, the transmitter 715, or various combinations or components thereof may be implemented in code (e.g., as communications management software or firmware) executed by a processor. If implemented in code executed by a processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication at a UE in accordance with examples as disclosed herein. For example, the communications manager 720 may be configured as or otherwise support a means for transmitting, to a network entity, an indication of a capability of the UE to support a CMR that includes two or more CSI-RS resources for CJT CSI reporting for multiple TRPs. The communications manager 720 may be configured as or otherwise support a means for receiving, from the network entity, control signaling indicating a CMR configuration that identifies a set of CSI-RS resources for CJT CSI reporting for the multiple TRPs, the CMR configuration based on the capability of the UE to support the CMR that includes two or more CSI-RS resources. The communications manager 720 may be configured as or otherwise support a means for transmitting, to the network entity, a CJT channel measurement report determined based on the CMR configuration of the set of CSI-RS resources.

By including or configuring the communications manager 720 in accordance with examples as described herein, the device 705 (e.g., a processor controlling or otherwise coupled with the receiver 710, the transmitter 715, the communications manager 720, or a combination thereof) may support techniques for more efficient utilization of communication resources. For example, the communications manager 720 may support determination and reporting of CSI based on a CMR configuration. The CSI may support CJTs from multiple TRPs, which may more efficiently utilize communication resources, decrease overhead, increase communication quality, and increase available power.

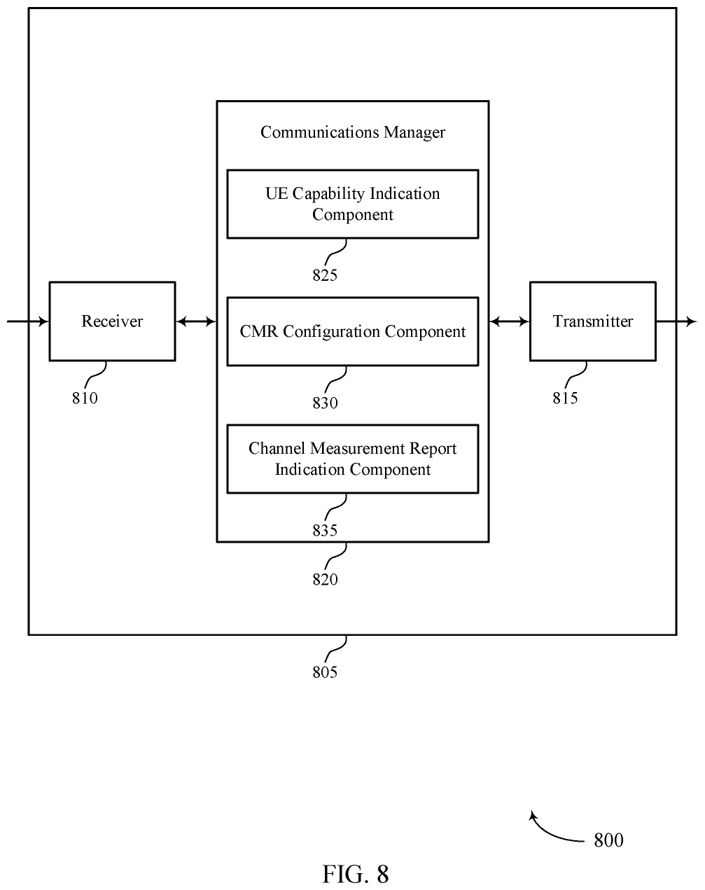

FIG. 8 shows a block diagram 800 of a device 805 that supports CSI configurations for joint transmissions from multiple TRPs in accordance with one or more aspects of the present disclosure. The device 805 may be an example of aspects of a device 705 or a UE 115 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to CSI configurations for joint transmissions from multiple TRPs). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to CSI configurations for joint transmissions from multiple TRPs). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of CSI configurations for joint transmissions from multiple TRPs as described herein. For example, the communications manager 820 may include a UE capability indication component 825, an CMR configuration component 830, a channel measurement report indication component 835, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communication at a UE in accordance with examples as disclosed herein. The UE capability indication component 825 may be configured as or otherwise support a means for transmitting, to a network entity, an indication of a capability of the UE to support a CMR that includes two or more CSI-RS resources for CJT CSI reporting for multiple TRPs. The CMR configuration component 830 may be configured as or otherwise support a means for receiving, from the network entity, control signaling indicating a CMR configuration that identifies a set of CSI-RS resources for CJT CSI reporting for the multiple TRPs, the CMR configuration based on the capability of the UE to support the CMR that includes two or more CSI-RS resources. The channel measurement report indication component 835 may be configured as or otherwise support a means for transmitting, to the network entity, a CJT channel measurement report determined based on the CMR configuration of the set of CSI-RS resources.

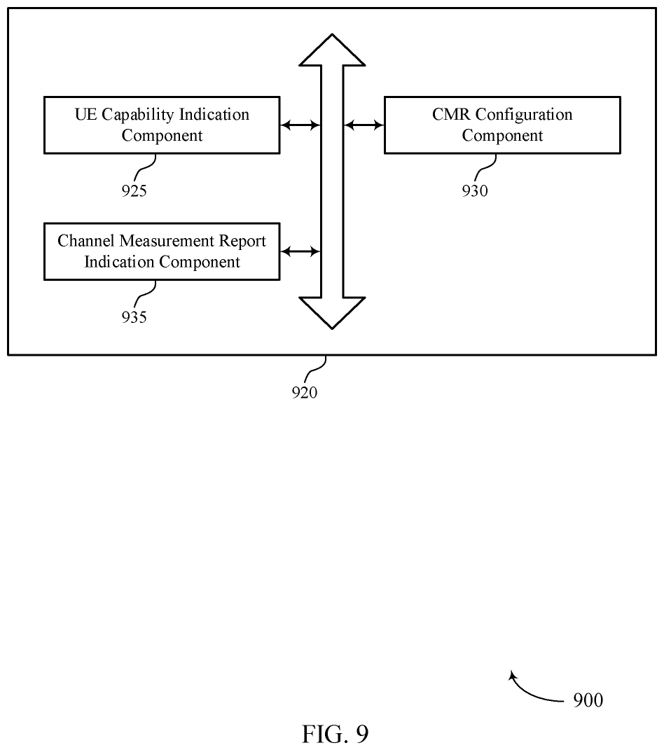

FIG. 9 shows a block diagram 900 of a communications manager 920 that supports CSI configurations for joint transmissions from multiple TRPs in accordance with one or more aspects of the present disclosure. The communications manager 920 may be an example of aspects of a communications manager 720, a communications manager 820, or both, as described herein. The communications manager 920, or various components thereof, may be an example of means for performing various aspects of CSI configurations for joint transmissions from multiple TRPs as described herein. For example, the communications manager 920 may include a UE capability indication component 925, an CMR configuration component 930, a channel measurement report indication component 935, or any combination thereof. Each of these components may communicate, directly or indirectly, with one another (e.g., via one or more buses).

The communications manager 920 may support wireless communication at a UE in accordance with examples as disclosed herein. The UE capability indication component 925 may be configured as or otherwise support a means for transmitting, to a network entity, an indication of a capability of the UE to support a CMR that includes two or more CSI-RS resources for CJT CSI reporting for multiple TRPs. The CMR configuration component 930 may be configured as or otherwise support a means for receiving, from the network entity, control signaling indicating a CMR configuration that identifies a set of CSI-RS resources for CJT CSI reporting for the multiple TRPs, the CMR configuration based on the capability of the UE to support the CMR that includes two or more CSI-RS resources. The channel measurement report indication component 935 may be configured as or otherwise support a means for transmitting, to the network entity, a CJT channel measurement report determined based on the CMR configuration of the set of CSI-RS resources.

In some examples, to support receiving the control signaling indicating the CMR configuration, the CMR configuration component 930 may be configured as or otherwise support a means for receiving the control signaling indicating the CMR configuration that identifies the set of CSI-RS resources including two or more CSI-RS resources each associated with a different quantity of ports.

In some examples, to support receiving the control signaling indicating the CMR configuration, the CMR configuration component 930 may be configured as or otherwise support a means for receiving the control signaling indicating the CMR configuration that identifies a respective CSI-RS resource of the set of CSI-RS resources associated with a group of two or more TRPs of the multiple TRPs, the respective CSI-RS resource associated with a set of ports corresponding to the group two or more TRPs.

In some examples, to support receiving the control signaling indicating the CMR configuration, the CMR configuration component 930 may be configured as or otherwise support a means for receiving the control signaling indicating the CMR configuration that identifies a second respective CSI-RS resource of the set of CSI-RS resources associated with a TRP of the multiple TRPs, the respective CSI-RS resource associated with a second set of ports corresponding to the TRP, where the set of ports is associated with a first quantity of ports and the second set of ports is associated with a second quantity of ports differing from the first quantity of ports.

In some examples, to support receiving the control signaling indicating the CMR configuration, the CMR configuration component 930 may be configured as or otherwise support a means for receiving the control signaling indicating the CMR configuration that identifies the set of CSI-RS resources including time resources that include a first time resource, a last time resource, and time resources between the first time resource and the last time resource in one or more consecutive slots, the time resources associated with one communication direction.

In some examples, to support transmitting the CJT channel measurement report, the channel measurement report indication component 935 may be configured as or otherwise support a means for transmitting, in a discontinuous reception mode, the CJT channel measurement report, where the CTJ channel measurement report is transmitted based on receiving, within a same active time of the discontinuous reception mode, each CSI-RS resource from the set of CSI-RS resources.

In some examples, to support transmitting the CJT channel measurement report, the channel measurement report indication component 935 may be configured as or otherwise support a means for transmitting, in a discontinuous reception mode, the CJT channel measurement report associated with a hypothesis used for selecting TRPs of the multiple TRPs for CJT, where the CJT channel measurement report for the hypothesis is transmitted based on receiving, within a same active time of the discontinuous reception mode, each CSI-RS resource that is associated with the hypothesis from the set of CSI-RS resources.

In some examples, to support transmitting the CJT channel measurement report, the channel measurement report indication component 935 may be configured as or otherwise support a means for refraining from transmitting, in the discontinuous reception mode, a second CJT channel measurement report associated with a second hypothesis used for selecting TRPs of the multiple TRPs for CJT based on the UE failing to receive, within the same active time of the discontinuous reception mode, at least one CSI-RS resource that is associated with the second hypothesis from the set of CSI-RS resources.

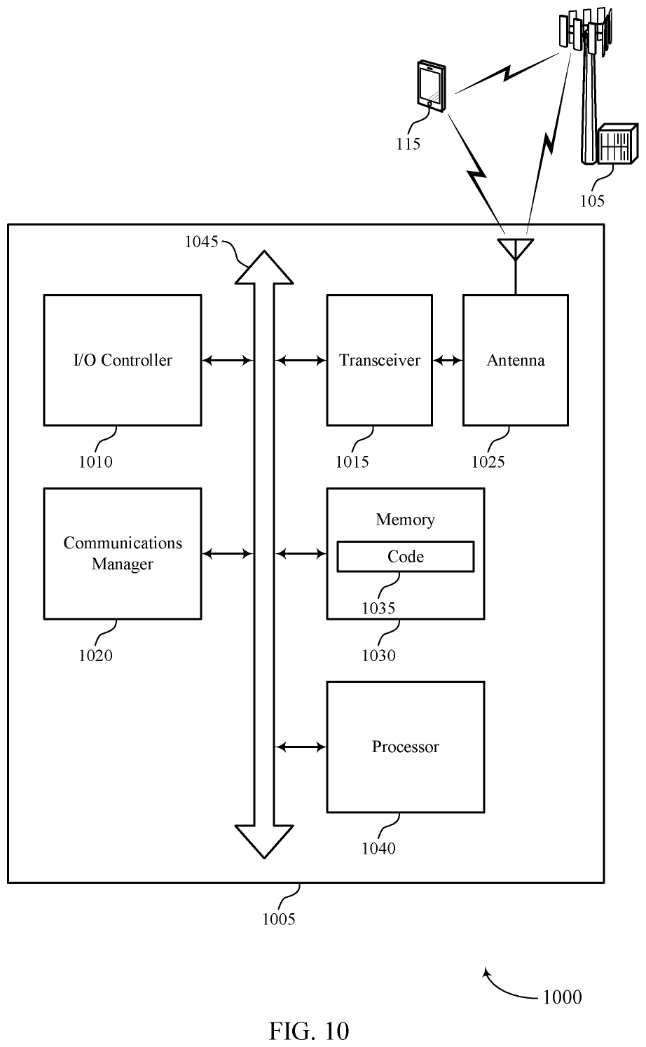

FIG. 10 shows a diagram of a system 1000 including a device 1005 that supports CSI configurations for joint transmissions from multiple TRPs in accordance with one or more aspects of the present disclosure. The device 1005 may be an example of or include the components of a device 705, a device 805, or a UE 115 as described herein. The device 1005 may communicate (e.g., wirelessly) with one or more network entities 105, one or more UEs 115, or any combination thereof. The device 1005 may include components for bi-directional voice and data communications including components for transmitting and receiving communications, such as a communications manager 1020, an input/output (I/O) controller 1010, a transceiver 1015, an antenna 1025, a memory 1030, code 1035, and a processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally, or alternatively, the I/O controller 1010 may represent or interact with a modem, a keyboard, a mouse, a touchscreen, or a similar device. In some cases, the I/O controller 1010 may be implemented as part of a processor, such as the processor 1040. In some cases, a user may interact with the device 1005 via the I/O controller 1010 or via hardware components controlled by the I/O controller 1010.

In some cases, the device 1005 may include a single antenna 1025. However, in some other cases, the device 1005 may have more than one antenna 1025, which may be capable of concurrently transmitting or receiving multiple wireless transmissions. The transceiver 1015 may communicate bi-directionally, via the one or more antennas 1025, wired, or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The memory 1030 may include random access memory (RAM) and read-only memory (ROM). The memory 1030 may store computer-readable, computer-executable code 1035 including instructions that, when executed by the processor 1040, cause the device 1005 to perform various functions described herein. The code 1035 may be stored in a non-transitory computer-readable medium such as system memory or another type of memory. In some cases, the code 1035 may not be directly executable by the processor 1040 but may cause a computer (e.g., when compiled and executed) to perform functions described herein. In some cases, the memory 1030 may contain, among other things, a basic I/O system (BIOS) which may control basic hardware or software operation such as the interaction with peripheral components or devices.

The processor 1040 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1040 may be configured to operate a memory array using a memory controller. In some other cases, a memory controller may be integrated into the processor 1040. The processor 1040 may be configured to execute computer-readable instructions stored in a memory (e.g., the memory 1030) to cause the device 1005 to perform various functions (e.g., functions or tasks supporting CSI configurations for joint transmissions from multiple TRPs). For example, the device 1005 or a component of the device 1005 may include a processor 1040 and memory 1030 coupled with or to the processor 1040, the processor 1040 and memory 1030 configured to perform various functions described herein.

The communications manager 1020 may support wireless communication at a UE in accordance with examples as disclosed herein. For example, the communications manager 1020 may be configured as or otherwise support a means for transmitting, to a network entity, an indication of a capability of the UE to support a CMR that includes two or more CSI-RS resources for CJT CSI reporting for multiple TRPs. The communications manager 1020 may be configured as or otherwise support a means for receiving, from the network entity, control signaling indicating a CMR configuration that identifies a set of CSI-RS resources for CJT CSI reporting for the multiple TRPs, the CMR configuration based on the capability of the UE to support the CMR that includes two or more CSI-RS resources. The communications manager 1020 may be configured as or otherwise support a means for transmitting, to the network entity, a CJT channel measurement report determined based on the CMR configuration of the set of CSI-RS resources.

By including or configuring the communications manager 1020 in accordance with examples as described herein, the device 1005 may support techniques for more efficient utilization of communication resources. For example, the communications manager 1020 may support determination and reporting of CSI based on a CMR configuration. The CSI may support CJTs from multiple TRPs, which may more efficiently utilize communication resources, decrease overhead, increase communication quality, and increase available power.

In some examples, the communications manager 1020 may be configured to perform various operations (e.g., receiving, monitoring, transmitting) using or otherwise in cooperation with the transceiver 1015, the one or more antennas 1025, or any combination thereof. For example, the communications manager 1020 may be configured to receive or transmit messages or other signaling as described herein via the transceiver 1015. Although the communications manager 1020 is illustrated as a separate component, in some examples, one or more functions described with reference to the communications manager 1020 may be supported by or performed by the processor 1040, the memory 1030, the code 1035, or any combination thereof. For example, the code 1035 may include instructions executable by the processor 1040 to cause the device 1005 to perform various aspects of CSI configurations for joint transmissions from multiple TRPs as described herein, or the processor 1040 and the memory 1030 may be otherwise configured to perform or support such operations.

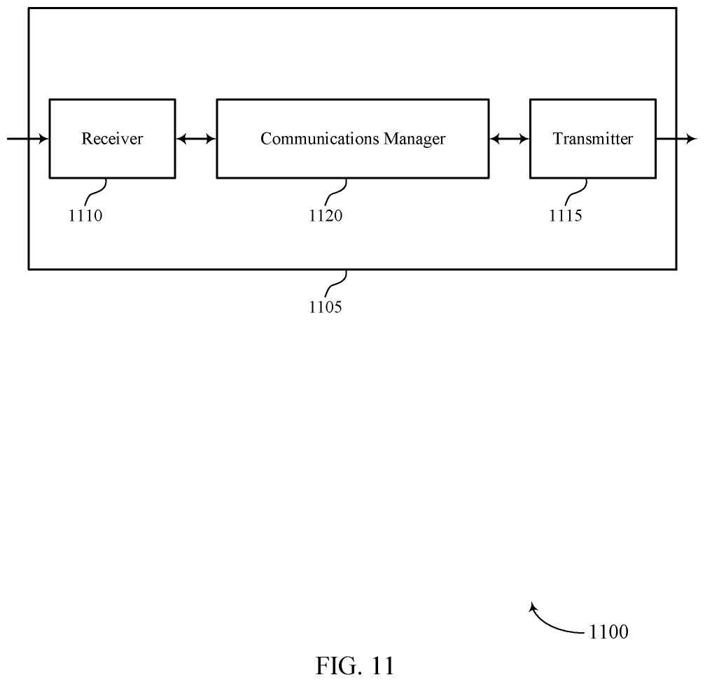

FIG. 11 shows a block diagram 1100 of a device 1105 that supports CSI configurations for joint transmissions from multiple TRPs in accordance with one or more aspects of the present disclosure. The device 1105 may be an example of aspects of a network entity 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The communications manager 1120, the receiver 1110, the transmitter 1115, or various combinations thereof or various components thereof may be examples of means for performing various aspects of CSI configurations for joint transmissions from multiple TRPs as described herein. For example, the communications manager 1120, the receiver 1110, the transmitter 1115, or various combinations or components thereof may support a method for performing one or more of the functions described herein.

In some examples, the communications manager 1120, the receiver 1110, the transmitter 1115, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1120, the receiver 1110, the transmitter 1115, or various combinations or components thereof may be implemented in code (e.g., as communications management software or firmware) executed by a processor. If implemented in code executed by a processor, the functions of the communications manager 1120, the receiver 1110, the transmitter 1115, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communication at a network entity in accordance with examples as disclosed herein. For example, the communications manager 1120 may be configured as or otherwise support a means for receiving an indication of a capability of a UE to support a CMR that includes two or more CSI-RS resources for CJT CSI reporting for multiple TRPs. The communications manager 1120 may be configured as or otherwise support a means for transmitting, for the UE, control signaling indicating a CMR configuration that identifies a set of CSI-RS resources for CJT CSI reporting for the multiple TRPs, the CMR configuration based on the capability of the UE to support the CMR that includes two or more CSI-RS resources. The communications manager 1120 may be configured as or otherwise support a means for receiving a CJT channel measurement report that is based on the CMR configuration of the set of CSI-RS resources.

By including or configuring the communications manager 1120 in accordance with examples as described herein, the device 1105 (e.g., a processor controlling or otherwise coupled with the receiver 1110, the transmitter 1115, the communications manager 1120, or a combination thereof) may support techniques for may support techniques for more efficient utilization of communication resources. For example, the communications manager 1120 may support determination and reporting of CSI based on a CMR configuration. The CSI may support CJTs from multiple TRPs, which may more efficiently utilize communication resources, decrease overhead, increase communication quality, and increase available power (e.g., by increasing communication quality and decreasing retransmissions).

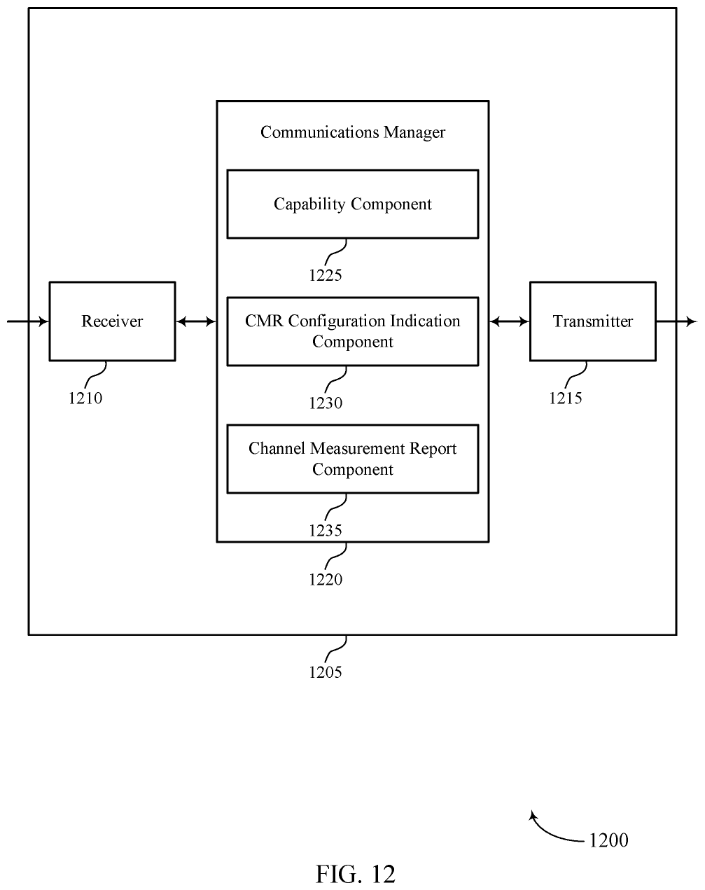

FIG. 12 shows a block diagram 1200 of a device 1205 that supports CSI configurations for joint transmissions from multiple TRPs in accordance with one or more aspects of the present disclosure. The device 1205 may be an example of aspects of a device 1105 or a network entity 105 as described herein. The device 1205 may include a receiver 1210, a transmitter 1215, and a communications manager 1220. The device 1205 may also include a processor. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The device 1205, or various components thereof, may be an example of means for performing various aspects of CSI configurations for joint transmissions from multiple TRPs as described herein. For example, the communications manager 1220 may include a capability component 1225, an CMR configuration indication component 1230, a channel measurement report component 1235, or any combination thereof. The communications manager 1220 may be an example of aspects of a communications manager 1120 as described herein. In some examples, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communication at a network entity in accordance with examples as disclosed herein. The capability component 1225 may be configured as or otherwise support a means for receiving an indication of a capability of a UE to support a CMR that includes two or more CSI-RS resources for CJT CSI reporting for multiple TRPs. The CMR configuration indication component 1230 may be configured as or otherwise support a means for transmitting, for the UE, control signaling indicating a CMR configuration that identifies a set of CSI-RS resources for CJT CSI reporting for the multiple TRPs, the CMR configuration based on the capability of the UE to support the CMR that includes two or more CSI-RS resources. The channel measurement report component 1235 may be configured as or otherwise support a means for receiving a CJT channel measurement report that is based on the CMR configuration of the set of CSI-RS resources.

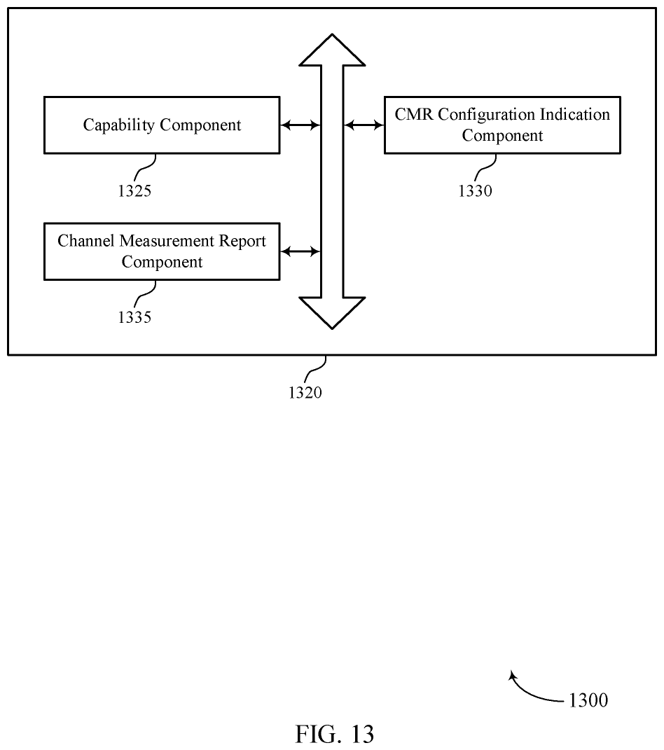

FIG. 13 shows a block diagram 1300 of a communications manager 1320 that supports CSI configurations for joint transmissions from multiple TRPs in accordance with one or more aspects of the present disclosure. The communications manager 1320 may be an example of aspects of a communications manager 1120, a communications manager 1220, or both, as described herein. The communications manager 1320, or various components thereof, may be an example of means for performing various aspects of CSI configurations for joint transmissions from multiple TRPs as described herein. For example, the communications manager 1320 may include a capability component 1325, an CMR configuration indication component 1330, a channel measurement report component 1335, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1320 may support wireless communication at a network entity in accordance with examples as disclosed herein. The capability component 1325 may be configured as or otherwise support a means for receiving an indication of a capability of a UE to support a CMR that includes two or more CSI-RS resources for CJT CSI reporting for multiple TRPs. The CMR configuration indication component 1330 may be configured as or otherwise support a means for transmitting, for the UE, control signaling indicating a CMR configuration that identifies a set of CSI-RS resources for CJT CSI reporting for the multiple TRPs, the CMR configuration based on the capability of the UE to support the CMR that includes two or more CSI-RS resources. The channel measurement report component 1335 may be configured as or otherwise support a means for receiving a CJT channel measurement report that is based on the CMR configuration of the set of CSI-RS resources.

In some examples, to support transmitting the control signaling indicating the CMR configuration, the CMR configuration indication component 1330 may be configured as or otherwise support a means for transmitting the control signaling indicating the CMR configuration that identifies the set of CSI-RS resources including two or more CSI-RS resources each associated with a different quantity of ports.

In some examples, to support transmitting the control signaling indicating the CMR configuration, the CMR configuration indication component 1330 may be configured as or otherwise support a means for transmitting the control signaling indicating the CMR configuration that identifies a respective CSI-RS resource of the set of CSI-RS resources associated with a group of two or more TRPs of the multiple TRPs, the respective CSI-RS resource associated with a set of ports corresponding to the group two or more TRPs.

In some examples, to support transmitting the control signaling indicating the CMR configuration, the CMR configuration indication component 1330 may be configured as or otherwise support a means for transmitting the control signaling indicating the CMR configuration that identifies a second respective CSI-RS resource of the set of CSI-RS resources associated with a TRP of the multiple TRPs, the respective CSI-RS resource associated with a second set of ports corresponding to the TRP, where the set of ports is associated with a first quantity of ports and the second set of ports is associated with a second quantity of ports differing from the first quantity of ports.

In some examples, to support transmitting the control signaling indicating the CMR configuration, the CMR configuration indication component 1330 may be configured as or otherwise support a means for transmitting the control signaling indicating the CMR configuration that identifies the set of CSI-RS resources including time resources that include a first time resource, a last time resource, and time resources between the first time resource and the last time resource in one or more consecutive slots, the time resources associated with one communication direction.

In some examples, to support receiving the CJT channel measurement report, the channel measurement report component 1335 may be configured as or otherwise support a means for receiving the CJT channel measurement report associated with a hypothesis used for selecting TRPs of the multiple TRPs for CJT, where the CJT channel measurement report for the hypothesis is received based on the UE receiving, within a same active time of a discontinuous reception mode of the UE, each CSI-RS resource that is associated with the hypothesis from the set of CSI-RS resources.

In some examples, to support receiving the CJT channel measurement report, the channel measurement report component 1335 may be configured as or otherwise support a means for receiving, in a discontinuous reception mode, the CJT channel measurement report, where the CJT channel measurement report is received based on transmitting, within a same active time of the discontinuous reception mode, each CSI-RS resource from the set of CSI-RS resources.

In some examples, the hypothesis is other than a second hypothesis for which the UE fails to receive, within the same active time of the discontinuous reception mode, at least one CSI-RS resource that is associated with the second hypothesis from the set of CSI-RS resources.

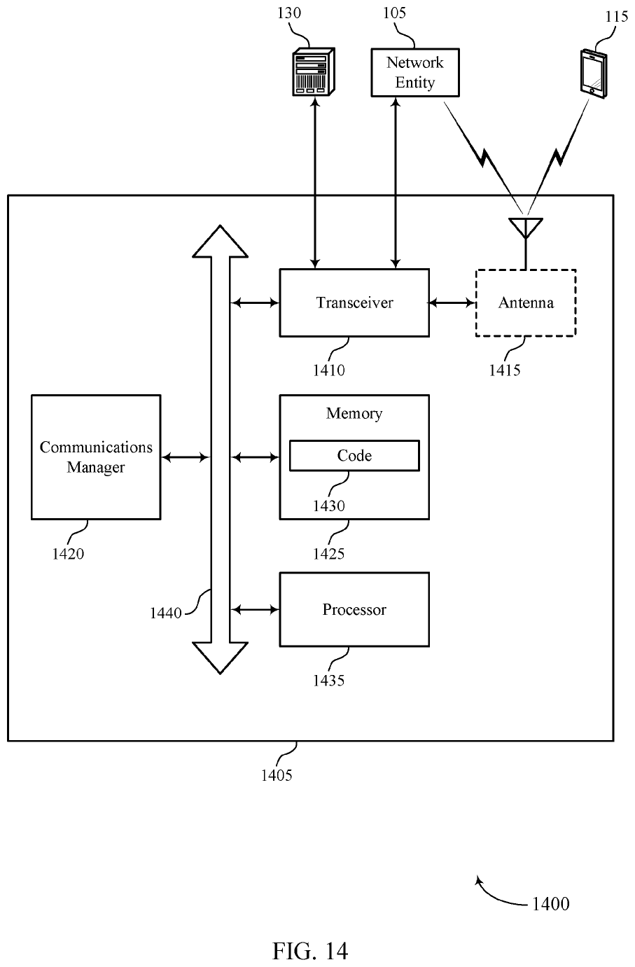

FIG. 14 shows a diagram of a system 1400 including a device 1405 that supports CSI configurations for joint transmissions from multiple TRPs in accordance with one or more aspects of the present disclosure. The device 1405 may be an example of or include the components of a device 1105, a device 1205, or a network entity 105 as described herein. The device 1405 may communicate with one or more network entities 105, one or more UEs 115, or any combination thereof, which may include communications over one or more wired interfaces, over one or more wireless interfaces, or any combination thereof. The device 1405 may include components that support outputting and obtaining communications, such as a communications manager 1420, a transceiver 1410, an antenna 1415, a memory 1425, code 1430, and a processor 1435. These components may be in electronic communication or otherwise coupled (e.g., operatively, communicatively, functionally, electronically, electrically) via one or more buses (e.g., a bus 1440).

The transceiver 1410 may support bi-directional communications via wired links, wireless links, or both as described herein. In some examples, the transceiver 1410 may include a wired transceiver and may communicate bi-directionally with another wired transceiver. Additionally, or alternatively, in some examples, the transceiver 1410 may include a wireless transceiver and may communicate bi-directionally with another wireless transceiver. In some examples, the device 1405 may include one or more antennas 1415, which may be capable of transmitting or receiving wireless transmissions (e.g., concurrently). The transceiver 1410 may also include a modem to modulate signals, to provide the modulated signals for transmission (e.g., by one or more antennas 1415, by a wired transmitter), to receive modulated signals (e.g., from one or more antennas 1415, from a wired receiver), and to demodulate signals. In some implementations, the transceiver 1410 may include one or more interfaces, such as one or more interfaces coupled with the one or more antennas 1415 that are configured to support various receiving or obtaining operations, or one or more interfaces coupled with the one or more antennas 1415 that are configured to support various transmitting or outputting operations, or a combination thereof. In some implementations, the transceiver 1410 may include or be configured for coupling with one or more processors or memory components that are operable to perform or support operations based on received or obtained information or signals, or to generate information or other signals for transmission or other outputting, or any combination thereof. In some implementations, the transceiver 1410, or the transceiver 1410 and the one or more antennas 1415, or the transceiver 1410 and the one or more antennas 1415 and one or more processors or memory components (for example, the processor 1435, or the memory 1425, or both), may be included in a chip or chip assembly that is installed in the device 1405. In some examples, the transceiver may be operable to support communications via one or more communications links (e.g., a communication link 125, a backhaul communication link 120, a midhaul communication link 162, a fronthaul communication link 168).

The memory 1425 may include RAM and ROM. The memory 1425 may store computer-readable, computer-executable code 1430 including instructions that, when executed by the processor 1435, cause the device 1405 to perform various functions described herein. The code 1430 may be stored in a non-transitory computer-readable medium such as system memory or another type of memory. In some cases, the code 1430 may not be directly executable by the processor 1435 but may cause a computer (e.g., when compiled and executed) to perform functions described herein. In some cases, the memory 1425 may contain, among other things, a BIOS which may control basic hardware or software operation such as the interaction with peripheral components or devices.

The processor 1435 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1435 may be configured to operate a memory array using a memory controller. In some other cases, a memory controller may be integrated into the processor 1435. The processor 1435 may be configured to execute computer-readable instructions stored in a memory (e.g., the memory 1425) to cause the device 1405 to perform various functions (e.g., functions or tasks supporting CSI configurations for joint transmissions from multiple TRPs). For example, the device 1405 or a component of the device 1405 may include a processor 1435 and memory 1425 coupled with the processor 1435, the processor 1435 and memory 1425 configured to perform various functions described herein. The processor 1435 may be an example of a cloud-computing platform (e.g., one or more physical nodes and supporting software such as operating systems, virtual machines, or container instances) that may host the functions (e.g., by executing code 1430) to perform the functions of the device 1405. The processor 1435 may be any one or more suitable processors capable of executing scripts or instructions of one or more software programs stored in the device 1405 (such as within the memory 1425). In some implementations, the processor 1435 may be a component of a processing system. A processing system may generally refer to a system or series of machines or components that receives inputs and processes the inputs to produce a set of outputs (which may be passed to other systems or components of, for example, the device 1405). For example, a processing system of the device 1405 may refer to a system including the various other components or subcomponents of the device 1405, such as the processor 1435, or the transceiver 1410, or the communications manager 1420, or other components or combinations of components of the device 1405. The processing system of the device 1405 may interface with other components of the device 1405, and may process information received from other components (such as inputs or signals) or output information to other components. For example, a chip or modem of the device 1405 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1405 may transmit information output from the chip or modem. Additionally, or alternatively, in some implementations, the one or more interfaces may refer to an interface between the processing system of the chip or modem and a receiver, such that the device 1405 may obtain information or signal inputs, and the information may be passed to the processing system. A person having ordinary skill in the art will readily recognize that a first interface also may obtain information or signal inputs, and a second interface also may output information or signal outputs.

In some examples, a bus 1440 may support communications of (e.g., within) a protocol layer of a protocol stack. In some examples, a bus 1440 may support communications associated with a logical channel of a protocol stack (e.g., between protocol layers of a protocol stack), which may include communications performed within a component of the device 1405, or between different components of the device 1405 that may be co-located or located in different locations (e.g., where the device 1405 may refer to a system in which one or more of the communications manager 1420, the transceiver 1410, the memory 1425, the code 1430, and the processor 1435 may be located in one of the different components or divided between different components).

In some examples, the communications manager 1420 may manage aspects of communications with a core network 130 (e.g., via one or more wired or wireless backhaul links). For example, the communications manager 1420 may manage the transfer of data communications for client devices, such as one or more UEs 115. In some examples, the communications manager 1420 may manage communications with other network entities 105, and may include a controller or scheduler for controlling communications with UEs 115 in cooperation with other network entities 105. In some examples, the communications manager 1420 may support an X2 interface within an LTE/LTE-A wireless communications network technology to provide communication between network entities 105.

The communications manager 1420 may support wireless communication at a network entity in accordance with examples as disclosed herein. For example, the communications manager 1420 may be configured as or otherwise support a means for receiving an indication of a capability of a UE to support a CMR that includes two or more CSI-RS resources for CJT CSI reporting for multiple TRPs. The communications manager 1420 may be configured as or otherwise support a means for transmitting, for the UE, control signaling indicating a CMR configuration that identifies a set of CSI-RS resources for CJT CSI reporting for the multiple TRPs, the CMR configuration based on the capability of the UE to support the CMR that includes two or more CSI-RS resources. The communications manager 1420 may be configured as or otherwise support a means for receiving a CJT channel measurement report that is based on the CMR configuration of the set of CSI-RS resources.

By including or configuring the communications manager 1420 in accordance with examples as described herein, the device 1405 may support techniques for may support techniques for more efficient utilization of communication resources. For example, the communications manager 1420 may support determination and reporting of CSI based on a CMR configuration. The CSI may support CJTs from multiple TRPs, which may more efficiently utilize communication resources, decrease overhead, increase communication quality, and increase available power.

In some examples, the communications manager 1420 may be configured to perform various operations (e.g., receiving, obtaining, monitoring, outputting, transmitting) using or otherwise in cooperation with the transceiver 1410, the one or more antennas 1415 (e.g., where applicable), or any combination thereof. For example, the communications manager 1420 may be configured to receive or transmit messages or other signaling as described herein via the transceiver 1410. Although the communications manager 1420 is illustrated as a separate component, in some examples, one or more functions described with reference to the communications manager 1420 may be supported by or performed by the transceiver 1410, the processor 1435, the memory 1425, the code 1430, or any combination thereof. For example, the code 1430 may include instructions executable by the processor 1435 to cause the device 1405 to perform various aspects of CSI configurations for joint transmissions from multiple TRPs as described herein, or the processor 1435 and the memory 1425 may be otherwise configured to perform or support such operations.

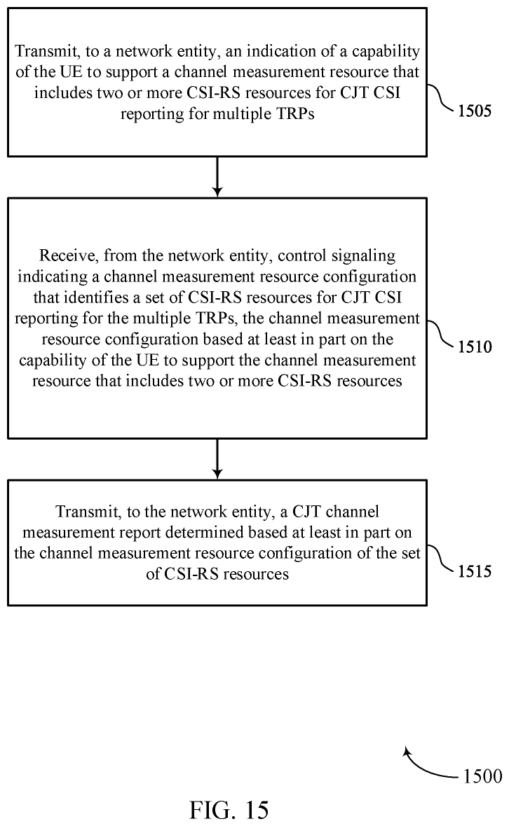

FIG. 15 shows a flowchart illustrating a method 1500 that supports CSI configurations for joint transmissions from multiple TRPs in accordance with one or more aspects of the present disclosure. The operations of the method 1500 may be implemented by a UE or its components as described herein. For example, the operations of the method 1500 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1505, the method may include transmitting, to a network entity, an indication of a capability of the UE to support a CMR that includes two or more CSI-RS resources for CJT CSI reporting for multiple TRPs. The operations of 1505 may be performed in accordance with examples as disclosed herein. In some examples, aspects of the operations of 1505 may be performed by a UE capability indication component 925 as described with reference to FIG. 9. Additionally, or alternatively, means for performing 1505 may, but not necessarily, include, for example, antenna 1025, transceiver 1015, communications manager 1020, memory 1030 (including code 1035), processor 1040 and/or bus 1045.

At 1510, the method may include receiving, from the network entity, control signaling indicating a CMR configuration that identifies a set of CSI-RS resources for CJT CSI reporting for the multiple TRPs, the CMR configuration based on the capability of the UE to support the CMR that includes two or more CSI-RS resources. The operations of 1510 may be performed in accordance with examples as disclosed herein. In some examples, aspects of the operations of 1510 may be performed by an CMR configuration component 930 as described with reference to FIG. 9. Additionally, or alternatively, means for performing 1510 may, but not necessarily, include, for example, antenna 1025, transceiver 1015, communications manager 1020, memory 1030 (including code 1035), processor 1040 and/or bus 1045.

At 1515, the method may include transmitting, to the network entity, a CJT channel measurement report determined based on the CMR configuration of the set of CSI-RS resources. The operations of 1515 may be performed in accordance with examples as disclosed herein. In some examples, aspects of the operations of 1515 may be performed by a channel measurement report indication component 935 as described with reference to FIG. 9. Additionally, or alternatively, means for performing 1515 may, but not necessarily, include, for example, antenna 1025, transceiver 1015, communications manager 1020, memory 1030 (including code 1035), processor 1040 and/or bus 1045.

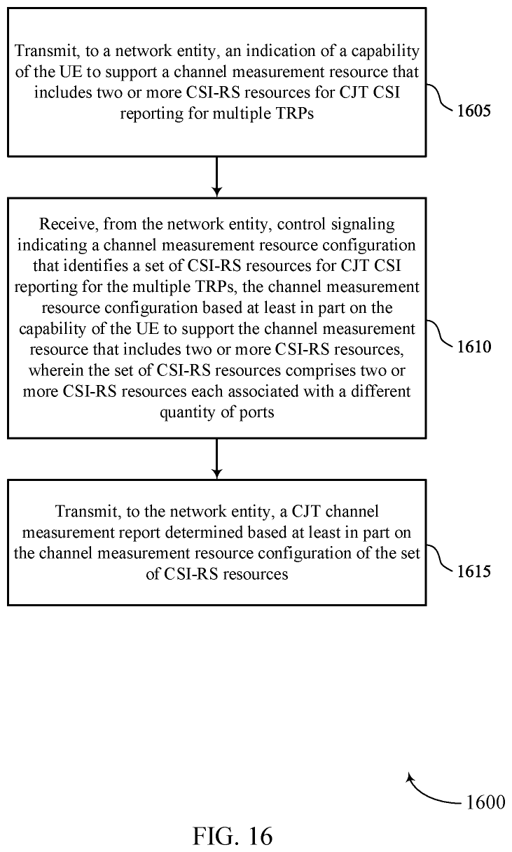

FIG. 16 shows a flowchart illustrating a method 1600 that supports CSI configurations for joint transmissions from multiple TRPs in accordance with one or more aspects of the present disclosure. The operations of the method 1600 may be implemented by a UE or its components as described herein. For example, the operations of the method 1600 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1605, the method may include transmitting, to a network entity, an indication of a capability of the UE to support a CMR that includes two or more CSI-RS resources for CJT CSI reporting for multiple TRPs. The operations of 1605 may be performed in accordance with examples as disclosed herein. In some examples, aspects of the operations of 1605 may be performed by a UE capability indication component 925 as described with reference to FIG. 9. Additionally, or alternatively, means for performing 1605 may, but not necessarily, include, for example, antenna 1025, transceiver 1015, communications manager 1020, memory 1030 (including code 1035), processor 1040 and/or bus 1045.

At 1610, the method may include receiving, from the network entity, control signaling indicating a CMR configuration that identifies a set of CSI-RS resources for CJT CSI reporting for the multiple TRPs, the CMR configuration based on the capability of the UE to support the CMR that includes two or more CSI-RS resources, where the set of CSI-RS resources includes two or more CSI-RS resources each associated with a different quantity of ports. The operations of 1610 may be performed in accordance with examples as disclosed herein. In some examples, aspects of the operations of 1610 may be performed by an CMR configuration component 930 as described with reference to FIG. 9. Additionally, or alternatively, means for performing 1610 may, but not necessarily, include, for example, antenna 1025, transceiver 1015, communications manager 1020, memory 1030 (including code 1035), processor 1040 and/or bus 1045.

At 1615, the method may include transmitting, to the network entity, a CJT channel measurement report determined based on the CMR configuration of the set of CSI-RS resources. The operations of 1615 may be performed in accordance with examples as disclosed herein. In some examples, aspects of the operations of 1615 may be performed by a channel measurement report indication component 935 as described with reference to FIG. 9. Additionally, or alternatively, means for performing 1615 may, but not necessarily, include, for example, antenna 1025, transceiver 1015, communications manager 1020, memory 1030 (including code 1035), processor 1040 and/or bus 1045.

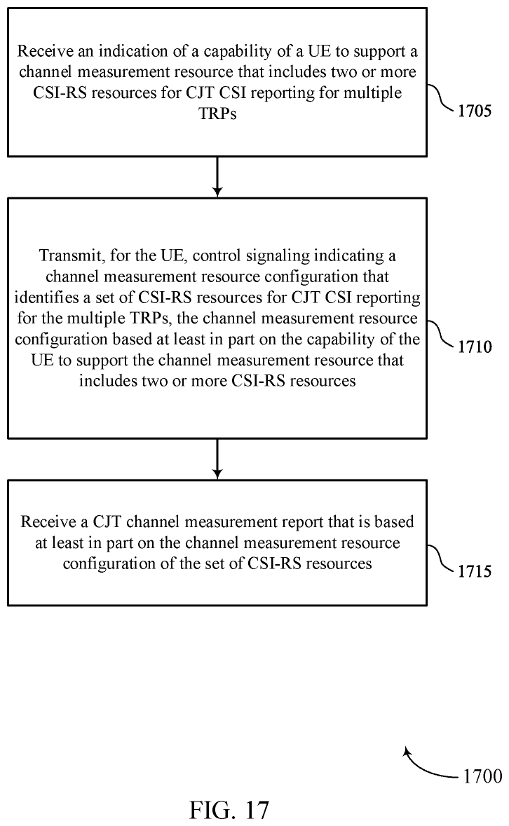

FIG. 17 shows a flowchart illustrating a method 1700 that supports CSI configurations for joint transmissions from multiple TRPs in accordance with one or more aspects of the present disclosure. The operations of the method 1700 may be implemented by a network entity or its components as described herein. For example, the operations of the method 1700 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 1705, the method may include receiving an indication of a capability of a UE to support a CMR that includes two or more CSI-RS resources for CJT CSI reporting for multiple TRPs. The operations of 1705 may be performed in accordance with examples as disclosed herein. In some examples, aspects of the operations of 1705 may be performed by a capability component 1325 as described with reference to FIG. 13. Additionally, or alternatively, means for performing 1705 may, but not necessarily, include, for example, antenna 1415, transceiver 1410, communications manager 1420, memory 1425 (including code 1430), processor 1435 and/or bus 1440.

At 1710, the method may include transmitting, for the UE, control signaling indicating a CMR configuration that identifies a set of CSI-RS resources for CJT CSI reporting for the multiple TRPs, the CMR configuration based on the capability of the UE to support the CMR that includes two or more CSI-RS resources. The operations of 1710 may be performed in accordance with examples as disclosed herein. In some examples, aspects of the operations of 1710 may be performed by an CMR configuration indication component 1330 as described with reference to FIG. 13. Additionally, or alternatively, means for performing 1710 may, but not necessarily, include, for example, antenna 1415, transceiver 1410, communications manager 1420, memory 1425 (including code 1430), processor 1435 and/or bus 1440.

At 1715, the method may include receiving a CJT channel measurement report that is based on the CMR configuration of the set of CSI-RS resources. The operations of 1715 may be performed in accordance with examples as disclosed herein. In some examples, aspects of the operations of 1715 may be performed by a channel measurement report component 1335 as described with reference to FIG. 13. Additionally, or alternatively, means for performing 1715 may, but not necessarily, include, for example, antenna 1415, transceiver 1410, communications manager 1420, memory 1425 (including code 1430), processor 1435 and/or bus 1440.

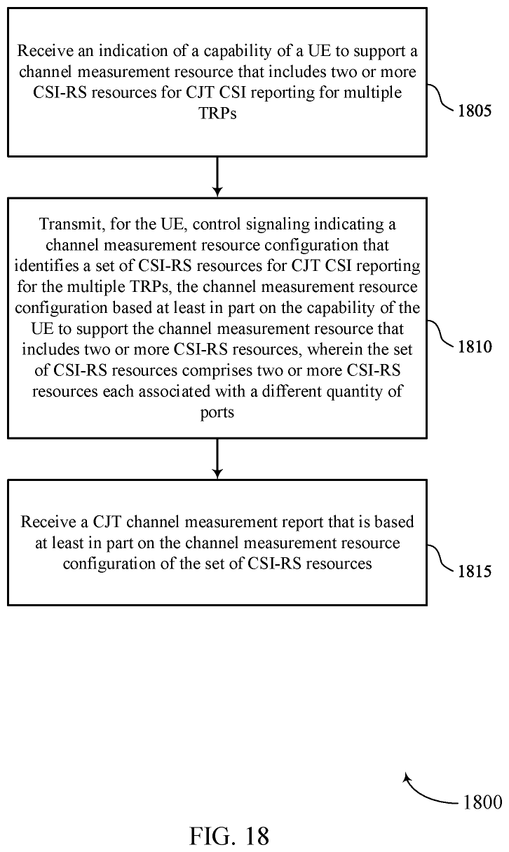

FIG. 18 shows a flowchart illustrating a method 1800 that supports CSI configurations for joint transmissions from multiple TRPs in accordance with one or more aspects of the present disclosure. The operations of the method 1800 may be implemented by a network entity or its components as described herein. For example, the operations of the method 1800 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 1805, the method may include receiving an indication of a capability of a UE to support a CMR that includes two or more CSI-RS resources for CJT CSI reporting for multiple TRPs. The operations of 1805 may be performed in accordance with examples as disclosed herein. In some examples, aspects of the operations of 1805 may be performed by a capability component 1325 as described with reference to FIG. 13. Additionally, or alternatively, means for performing 1805 may, but not necessarily, include, for example, antenna 1415, transceiver 1410, communications manager 1420, memory 1425 (including code 1430), processor 1435 and/or bus 1440.

At 1810, the method may include transmitting, for the UE, control signaling indicating a CMR configuration that identifies a set of CSI-RS resources for CJT CSI reporting for the multiple TRPs, the CMR configuration based on the capability of the UE to support the CMR that includes two or more CSI-RS resources, where the set of CSI-RS resources includes two or more CSI-RS resources each associated with a different quantity of ports. The operations of 1810 may be performed in accordance with examples as disclosed herein. In some examples, aspects of the operations of 1810 may be performed by an CMR configuration indication component 1330 as described with reference to FIG. 13. Additionally, or alternatively, means for performing 1810 may, but not necessarily, include, for example, antenna 1415, transceiver 1410, communications manager 1420, memory 1425 (including code 1430), processor 1435 and/or bus 1440.

At 1815, the method may include receiving a CJT channel measurement report that is based on the CMR configuration of the set of CSI-RS resources. The operations of 1815 may be performed in accordance with examples as disclosed herein. In some examples, aspects of the operations of 1815 may be performed by a channel measurement report component 1335 as described with reference to FIG. 13. Additionally, or alternatively, means for performing 1815 may, but not necessarily, include, for example, antenna 1415, transceiver 1410, communications manager 1420, memory 1425 (including code 1430), processor 1435 and/or bus 1440.

The following provides an overview of aspects of the present disclosure:

Aspect 1: A method for wireless communication at a UE, comprising: transmitting, to a network entity, an indication of a capability of the UE to support a CMR that includes two or more CSI-RS resources for CJT CSI reporting for multiple TRPs; receiving, from the network entity, control signaling indicating a CMR configuration that identifies a set of CSI-RS resources for CJT CSI reporting for the multiple TRPs, the CMR configuration based at least in part on the capability of the UE to support the CMR that includes two or more CSI-RS resources; and transmitting, to the network entity, a CJT channel measurement report determined based at least in part on the CMR configuration of the set of CSI-RS resources.

Aspect 2: The method of aspect 1, wherein receiving the control signaling indicating the CMR configuration comprises: receiving the control signaling indicating the CMR configuration that identifies the set of CSI-RS resources comprising two or more CSI-RS resources each associated with a different quantity of ports.

Aspect 3: The method of any of aspects 1 through 2, wherein receiving the control signaling indicating the CMR configuration comprises: receiving the control signaling indicating the CMR configuration that identifies a respective CSI-RS resource of the set of CSI-RS resources associated with a group of two or more TRPs of the multiple TRPs, the respective CSI-RS resource associated with a set of ports corresponding to the group of two or more TRPs.

Aspect 4: The method of aspect 3, wherein receiving the control signaling indicating the CMR configuration comprises: receiving the control signaling indicating the CMR configuration that identifies a second respective CSI-RS resource of the set of CSI-RS resources associated with a TRP of the multiple TRPs, the respective CSI-RS resource associated with a second set of ports corresponding to the TRP, wherein the set of ports is associated with a first quantity of ports and the second set of ports is associated with a second quantity of ports differing from the first quantity of ports.

Aspect 5: The method of any of aspects 1 through 4, wherein receiving the control signaling indicating the CMR configuration comprises: receiving the control signaling indicating the CMR configuration that identifies the set of CSI-RS resources comprising time resources that include a first time resource, a last time resource, and time resources between the first time resource and the last time resource in one or more consecutive slots, the time resources associated with one communication direction.

Aspect 6: The method of any of aspects 1 through 5, wherein transmitting the CJT channel measurement report comprises: transmitting, in a discontinuous reception mode, the CJT channel measurement report, wherein the CJT channel measurement report is transmitted based at least in part on receiving, within a same active time of the discontinuous reception mode, each CSI-RS resource from the set of CSI-RS resources.

Aspect 7: The method of any of aspects 1 through 5, wherein transmitting the CJT channel measurement report comprises: transmitting, in a discontinuous reception mode, the CJT channel measurement report associated with a hypothesis used for selecting TRPs of the multiple TRPs for CJT, wherein the CJT channel measurement report for the hypothesis is transmitted based at least in part on receiving, within a same active time of the discontinuous reception mode, each CSI-RS resource that is associated with the hypothesis from the set of CSI-RS resources.

Aspect 8: The method of aspect 7, further comprising: refraining from transmitting, in the discontinuous reception mode, a second CJT channel measurement report associated with a second hypothesis used for selecting TRPs of the multiple TRPs for CJT based at least in part on the UE failing to receive, within the same active time of the discontinuous reception mode, at least one CSI-RS resource that is associated with the second hypothesis from the set of CSI-RS resources.

Aspect 9: A method for wireless communication at a network entity, comprising: receiving an indication of a capability of a UE to support a CMR that includes two or more CSI-RS resources for CJT CSI reporting for multiple TRPs; transmitting, for the UE, control signaling indicating a CMR configuration that identifies a set of CSI-RS resources for CJT CSI reporting for the multiple TRPs, the CMR configuration based at least in part on the capability of the UE to support the CMR that includes two or more CSI-RS resources; and receiving a CJT channel measurement report that is based at least in part on the CMR configuration of the set of CSI-RS resources.

Aspect 10: The method of aspect 9, wherein transmitting the control signaling indicating the CMR configuration comprises: transmitting the control signaling indicating the CMR configuration that identifies the set of CSI-RS resources comprising two or more CSI-RS resources each associated with a different quantity of ports.

Aspect 11: The method of any of aspects 9 through 10, wherein transmitting the control signaling indicating the CMR configuration comprises: transmitting the control signaling indicating the CMR configuration that identifies a respective CSI-RS resource of the set of CSI-RS resources associated with a group of two or more TRPs of the multiple TRPs, the respective CSI-RS resource associated with a set of ports corresponding to the group of two or more TRPs.

Aspect 12: The method of aspect 11, wherein transmitting the control signaling indicating the CMR configuration comprises: transmitting the control signaling indicating the CMR configuration that identifies a second respective CSI-RS resource of the set of CSI-RS resources associated with a TRP of the multiple TRPs, the respective CSI-RS resource associated with a second set of ports corresponding to the TRP, wherein the set of ports is associated with a first quantity of ports and the second set of ports is associated with a second quantity of ports differing from the first quantity of ports.

Aspect 13: The method of any of aspects 9 through 12, wherein transmitting the control signaling indicating the CMR configuration comprises: transmitting the control signaling indicating the CMR configuration that identifies the set of CSI-RS resources comprising time resources that include a first time resource, a last time resource, and time resources between the first time resource and the last time resource in one or more consecutive slots, the time resources associated with one communication direction.

Aspect 14: The method of any of aspects 9 through 13, wherein receiving the CJT channel measurement report comprises: receiving, in a discontinuous reception mode, the CJT channel measurement report, wherein the CJT channel measurement report is received based at least in part on transmitting, within a same active time of the discontinuous reception mode, each CSI-RS resource from the set of CSI-RS resources.

Aspect 15: The method of any of aspects 9 through 13, wherein receiving the CJT channel measurement report comprises: receiving the CJT channel measurement report associated with a hypothesis used for selecting TRPs of the multiple TRPs for CJT, wherein the CJT channel measurement report is received based at least in part on the UE receiving, within a same active time of a discontinuous reception mode of the UE, each CSI-RS resource that is associated with the hypothesis from the set of CSI-RS resources.

Aspect 16: The method of aspect 15, wherein the hypothesis is other than a second hypothesis for which the UE fails to receive, within the same active time of the discontinuous reception mode, at least one CSI-RS resource that is associated with the second hypothesis from the set of CSI-RS resources.

Aspect 17: An apparatus for wireless communication, comprising a memory; a transceiver; and at least one processor coupled with the memory and the transceiver, the at least one processor configured to cause the apparatus to perform a method of any of aspects 1 through 8.

Aspect 18: An apparatus for wireless communication at a UE, comprising at least one means for performing a method of any of aspects 1 through 8.

Aspect 19: A non-transitory computer-readable medium storing code for wireless communication at a UE, the code comprising instructions executable by a processor to perform a method of any of aspects 1 through 8.

Aspect 20: An apparatus for wireless communication, comprising a memory and at least on processor coupled with the memory, the at least one processor configured to perform a method of any of aspects 9 through 16.

Aspect 21: An apparatus for wireless communication at a network entity, comprising at least one means for performing a method of any of aspects 9 through 16.

Aspect 22: A non-transitory computer-readable medium storing code for wireless communication at a network entity, the code comprising instructions executable by a processor to perform a method of any of aspects 9 through 16.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication at a user equipment (UE), comprising:
transmitting, to a network entity, an indication of a capability of the UE to support a channel measurement resource that includes two or more channel state information reference signal resources for coherent joint transmission channel state information reporting for multiple transmission-reception points:
receiving, from the network entity, control signaling indicating a channel measurement resource configuration that identifies a set of channel state information reference signal resources for coherent joint transmission channel state information reporting for the multiple transmission-reception points, the channel measurement resource configuration based at least in part on the capability of the UE to support the channel measurement resource that includes two or more channel state information reference signal resources; and
transmitting, to the network entity, a coherent joint transmission channel measurement report determined based at least in part on the channel measurement resource configuration of the set of channel state information reference signal resources.

2. The method of claim 1, wherein receiving the control signaling indicating the channel measurement resource configuration comprises:
receiving the control signaling indicating the channel measurement resource configuration that identifies the set of channel state information reference signal resources comprising two or more channel state information reference signal resources each associated with a different quantity of ports.

3. The method of claim 1, wherein receiving the control signaling indicating the channel measurement resource configuration comprises:
receiving the control signaling indicating the channel measurement resource configuration that identifies a respective channel state information reference signal resource of the set of channel state information reference signal resources associated with a group of two or more transmission-reception points of the multiple transmission-reception points, the respective channel state information reference signal resource associated with a set of ports corresponding to the group of two or more transmission-reception points.

4. The method of claim 3, wherein receiving the control signaling indicating the channel measurement resource configuration comprises:
receiving the control signaling indicating the channel measurement resource configuration that identifies a second respective channel state information reference signal resource of the set of channel state information reference signal resources associated with a transmission-reception point of the multiple transmission-reception points, the respective channel state information reference signal resource associated with a second set of ports corresponding to the transmission-reception point, wherein the set of ports is associated with a first quantity of ports and the second set of ports is associated with a second quantity of ports differing from the first quantity of ports.

5. The method of claim 1, wherein receiving the control signaling indicating the channel measurement resource configuration comprises:
receiving the control signaling indicating the channel measurement resource configuration that identifies the set of channel state information reference signal resources comprising time resources that include a first time resource, a last time resource, and time resources between the first time resource and the last time resource in one or more consecutive slots, the time resources associated with one communication direction.

6. The method of claim 1, wherein transmitting the coherent joint transmission channel measurement report comprises:
transmitting, in a discontinuous reception mode, the coherent joint transmission channel measurement report, wherein the coherent joint transmission channel measurement report is transmitted based at least in part on receiving, within a same active time of the discontinuous reception mode, each channel state information reference signal resource from the set of channel state information reference signal resources.

7. The method of claim 1, wherein transmitting the coherent joint transmission channel measurement report comprises:
transmitting, in a discontinuous reception mode, the coherent joint transmission channel measurement report associated with a hypothesis used for selecting transmission-reception points of the multiple transmission-reception points for coherent joint transmission, wherein the coherent joint transmission channel measurement report for the hypothesis is transmitted based at least in part on receiving, within a same active time of the discontinuous reception mode, each channel state information reference signal resource that is associated with the hypothesis from the set of channel state information reference signal resources.

8. The method of claim 7, further comprising:
refraining from transmitting, in the discontinuous reception mode, a second coherent joint transmission channel measurement report associated with a second hypothesis used for selecting transmission-reception points of the multiple transmission-reception points for coherent joint transmission based at least in part on the UE failing to receive, within the same active time of the discontinuous reception mode, at least one channel state information reference signal resource that is associated with the second hypothesis from the set of channel state information reference signal resources.

9. A method for wireless communication at a network entity, comprising:
receiving an indication of a capability of a user equipment (UE) to support a channel measurement resource that includes two or more channel state information reference signal resources for coherent joint transmission channel state information reporting for multiple transmission-reception points:
transmitting, for the UE, control signaling indicating a channel measurement resource configuration that identifies a set of channel state information reference signal resources for coherent joint transmission channel state information reporting for the multiple transmission-reception points, the channel measurement resource configuration based at least in part on the capability of the UE to support the channel measurement resource that includes two or more channel state information reference signal resources; and
receiving a coherent joint transmission channel measurement report that is based at least in part on the channel measurement resource configuration of the set of channel state information reference signal resources.

10. The method of claim 9, wherein transmitting the control signaling indicating the channel measurement resource configuration comprises:
transmitting the control signaling indicating the channel measurement resource configuration that identifies the set of channel state information reference signal resources comprising two or more channel state information reference signal resources each associated with a different quantity of ports.

11. The method of claim 9, wherein transmitting the control signaling indicating the channel measurement resource configuration comprises:
transmitting the control signaling indicating the channel measurement resource configuration that identifies a respective channel state information reference signal resource of the set of channel state information reference signal resources associated with a group of two or more transmission-reception points of the multiple transmission-reception points, the respective channel state information reference signal resource associated with a set of ports corresponding to the group of two or more transmission-reception points.

12. The method of claim 11, wherein transmitting the control signaling indicating the channel measurement resource configuration comprises:
transmitting the control signaling indicating the channel measurement resource configuration that identifies a second respective channel state information reference signal resource of the set of channel state information reference signal resources associated with a transmission-reception point of the multiple transmission-reception points, the respective channel state information reference signal resource associated with a second set of ports corresponding to the transmission-reception point, wherein the set of ports is associated with a first quantity of ports and the second set of ports is associated with a second quantity of ports differing from the first quantity of ports.

13. The method of claim 9, wherein transmitting the control signaling indicating the channel measurement resource configuration comprises:
transmitting the control signaling indicating the channel measurement resource configuration that identifies the set of channel state information reference signal resources comprising time resources that include a first time resource, a last time resource, and time resources between the first time resource and the last time resource in one or more consecutive slots, the time resources associated with one communication direction.

14. The method of claim 9, wherein receiving the coherent joint transmission channel measurement report comprises:
receiving, in a discontinuous reception mode, the coherent joint transmission channel measurement report, wherein the coherent joint transmission channel measurement report is received based at least in part on transmitting, within a same active time of the discontinuous reception mode, each channel state information reference signal resource from the set of channel state information reference signal resources.

15. The method of claim 9, wherein receiving the coherent joint transmission channel measurement report comprises:
receiving the coherent joint transmission channel measurement report associated with a hypothesis used for selecting transmission-reception points of the multiple transmission-reception points for coherent joint transmission, wherein the coherent joint transmission channel measurement report for the hypothesis is received based at least in part on the UE receiving, within a same active time of a discontinuous reception mode of the UE, each channel state information reference signal resource that is associated with the hypothesis from the set of channel state information reference signal resources.

16. The method of claim 15, wherein the hypothesis is other than a second hypothesis for which the UE fails to receive, within the same active time of the discontinuous reception mode, at least one channel state information reference signal resource that is associated with the second hypothesis from the set of channel state information reference signal resources.

17. An apparatus for wireless communication, comprising:
memory:
a transceiver; and
at least one processor of a user equipment (UE), the at least one processor coupled with the memory and the transceiver, and the at least one processor configured to:
transmit, to a network entity and via the transceiver, an indication of a capability of the UE to support a channel measurement resource that includes two or more channel state information reference signal resources for coherent joint transmission channel state information reporting for multiple transmission-reception points;
receive, from the network entity and via the transceiver, control signaling indicating a channel measurement resource configuration that identifies a set of channel state information reference signal resources for coherent joint transmission channel state information reporting for the multiple transmission-reception points, the channel measurement resource configuration based at least in part on the capability of the UE to support the channel measurement resource that includes two or more channel state information reference signal resources; and
transmit, to the network entity and via the transceiver, a coherent joint transmission channel measurement report determined based at least in part on the channel measurement resource configuration of the set of channel state information reference signal resources.

18. The apparatus of claim 17, the at least one processor further configured to:
receive the control signaling indicating the channel measurement resource configuration that identifies the set of channel state information reference signal resources comprising two or more channel state information reference signal resources each associated with a different quantity of ports.

19. The apparatus of claim 17, the at least one processor further configured to:
receive the control signaling indicating the channel measurement resource configuration that identifies a respective channel state information reference signal resource of the set of channel state information reference signal resources associated with a group of two or more transmission-reception points of the multiple transmission-reception points, the respective channel state information reference signal resource associated with a set of ports corresponding to the group of two or more transmission-reception points.

20. The apparatus of claim 19, the at least one processor further configured to:
receive the control signaling indicating the channel measurement resource configuration that identifies a second respective channel state information reference signal resource of the set of channel state information reference signal resources associated with a transmission-reception point of the multiple transmission-reception points, the respective channel state information reference signal resource associated with a second set of ports corresponding to the transmission-reception point, wherein the set of ports is associated with a first quantity of ports and the second set of ports is associated with a second quantity of ports differing from the first quantity of ports.

21. The apparatus of claim 17, the at least one processor further configured to:
receive the control signaling indicating the channel measurement resource configuration that identifies the set of channel state information reference signal resources comprising time resources that include a first time resource, a last time resource, and time resources between the first time resource and the last time resource in one or more consecutive slots, the time resources associated with one communication direction.

22. The apparatus of claim 17, the at least one processor further configured to:
transmit, in a discontinuous reception mode, the coherent joint transmission channel measurement report associated with a hypothesis used for selecting transmission-reception points of the multiple transmission-reception points for coherent joint transmission, wherein the coherent joint transmission channel measurement report for the hypothesis is transmitted based at least in part on receiving, within a same active time of the discontinuous reception mode, each channel state information reference signal resource that is associated with the hypothesis from the set of channel state information reference signal resources.

23. The apparatus of claim 22, further comprising:
refrain from transmitting, in the discontinuous reception mode, a second coherent joint transmission channel measurement report associated with a second hypothesis used for selecting transmission-reception points of the multiple transmission-reception points for coherent joint transmission based at least in part on the UE failing to receive, within the same active time of the discontinuous reception mode, at least one channel state information reference signal resource that is associated with the second hypothesis from the set of channel state information reference signal resources.

24. An apparatus for wireless communication, comprising:
memory; and
at least one processor of a network entity, the at least one processor coupled with the memory, and the at least one processor configured to:
receive an indication of a capability of a user equipment (UE) to support a channel measurement resource that includes two or more channel state information reference signal resources for coherent joint transmission channel state information reporting for multiple transmission-reception points;
transmit, for the UE, control signaling indicating a channel measurement resource configuration that identifies a set of channel state information reference signal resources for coherent joint transmission channel state information reporting for the multiple transmission-reception points, the channel measurement resource configuration based at least in part on the capability of the UE to support the channel measurement resource that includes two or more channel state information reference signal resources; and
receive a coherent joint transmission channel measurement report that is based at least in part on the channel measurement resource configuration of the set of channel state information reference signal resources.

25. The apparatus of claim 24, the at least one processor further configured to:
transmit the control signaling indicating the channel measurement resource configuration that identifies the set of channel state information reference signal resources comprising two or more channel state information reference signal resources each associated with a different quantity of ports.

26. The apparatus of claim 24, the at least one processor further configured to:
transmit the control signaling indicating the channel measurement resource configuration that identifies a respective channel state information reference signal resource of the set of channel state information reference signal resources associated with a group of two or more transmission-reception points of the multiple transmission-reception points, the respective channel state information reference signal resource associated with a set of ports corresponding to the group of two or more transmission-reception points.

27. The apparatus of claim 26, the at least one processor further configured to:
transmit the control signaling indicating the channel measurement resource configuration that identifies a second respective channel state information reference signal resource of the set of channel state information reference signal resources associated with a transmission-reception point of the multiple transmission-reception points, the respective channel state information reference signal resource associated with a second set of ports corresponding to the transmission-reception point, wherein the set of ports is associated with a first quantity of ports and the second set of ports is associated with a second quantity of ports differing from the first quantity of ports.

28. The apparatus of claim 24, the at least one processor further configured to:
transmit the control signaling indicating the channel measurement resource configuration that identifies the set of channel state information reference signal resources comprising time resources that include a first time resource, a last time resource, and time resources between the first time resource and the last time resource in one or more consecutive slots, the time resources associated with one communication direction.

29. The apparatus of claim 24, the at least one processor further configured to:
receive the coherent joint transmission channel measurement report associated with a hypothesis used for selecting transmission-reception points of the multiple transmission-reception points for coherent joint transmission, wherein the coherent joint transmission channel measurement report for the hypothesis is received based at least in part on the UE receiving, within a same active time of a discontinuous reception mode of the UE, each channel state information reference signal resource that is associated with the hypothesis from the set of channel state information reference signal resources.

30. The apparatus of claim 29, wherein the hypothesis is other than a second hypothesis for which the UE fails to receive, within the same active time of the discontinuous reception mode, at least one channel state information reference signal resource that is associated with the second hypothesis from the set of channel state information reference signal resources.
